(19) United States
(12) Patent Application Publication
(10) Pub. No.: US 2011/0216995 A1
(43) Pub. Date: Sep. 8, 2011

(54) METHOD OF MANUFACTURING OPTICAL SENSOR MODULE AND OPTICAL SENSOR MODULE OBTAINED THEREBY

(75) Inventor: Masayuki Hodono, Osaka (JP)

(73) Assignee: NITTO DENKO CORPORATION, Osaka (JP)

(21) Appl. No.: 13/040,849

(22) Filed: Mar. 4, 2011

Related U.S. Application Data
(60) Provisional application No. 61/314,866, filed on Mar. 17, 2010.

(30) Foreign Application Priority Data
Mar. 5, 2010 (JP) 2010-048911

(51) Int. Cl. G02B 6/00; B29D 11/00

(52) U.S. Cl. 385/12; 216/24

(57) ABSTRACT

A method of manufacturing an optical sensor module which eliminates the need for the operation of alignment between a core in an optical waveguide unit and an optical element in a substrate unit and which does not reduce the accuracy of alignment, and an optical sensor module obtained thereby. An optical waveguide unit including protruding portions having vertical walls with a height less than 50 μm and groove portions, and a substrate unit including positioning members of respective positioning plate portions to be positioned in the protruding portions and fitting plate portions for fitting engagement with the groove portions are individually produced. Corners of the positioning members are positioned on the vertical walls of the protruding portions, and the fitting plate portions are brought into fitting engagement with the groove portions whereby the substrate unit and the optical waveguide unit are integrated together.

### RELATED APPLICATIONS

This application claims the benefit of U.S. Provisional Application No. 61/314,866 filed Mar. 17, 2010, which is hereby incorporated by reference.

### BACKGROUND OF THE INVENTION

1. Field of the Invention

The present invention relates to a method of manufacturing an optical sensor module including an optical waveguide unit and a substrate unit with an optical element mounted therein, and to an optical sensor module obtained thereby.

2. Description of the Related Art

As shown in FIGS. 13A and 13B, an optical sensor module may be manufactured by: individually producing an optical waveguide unit W₀ in which an under cladding layer 71, a core 72 and an over cladding layer 73 are disposed in the order named, and a substrate unit E₀ in which an optical element 82 is mounted on a substrate 81; and then connecting the above-mentioned substrate unit E₀ to an end portion of the above-mentioned optical waveguide unit W₀, with the core 72 of the above-mentioned optical waveguide unit W₀ and the optical element 82 of the substrate unit E₀ kept in alignment with each other. In FIGS. 13A and 13B, the reference numeral 74 designates an adhesive layer, 75 designates a base, 83 designates an insulation layer, 84 designates an optical element mounting pad, and 85 designates a transparent resin layer.

The above-mentioned alignment between the core 72 of the above-mentioned optical waveguide unit W₀ and the optical element 82 of the substrate unit E₀ is generally performed by using a self-aligning machine (see, for example, Japanese Published Patent Application No. 5-196831 (1993)). In this self-aligning machine, the alignment is performed, with the optical waveguide unit W₀ fixed on a fixed stage (not shown) and the substrate unit E₀ fixed on a movable stage (not shown). Specifically, when the above-mentioned optical element 82 is a light-emitting element, the alignment is as follows. As shown in FIG. 13A, while the position of the light-emitting element is changed relative to a first end surface (light entrance) 72a of the core 72, with light H₁ emitted from the light-emitting element, the amount of light emitted outwardly from a second end surface (light exit) 72b of the core 72 through a lens portion 73b provided in a second end portion of the over cladding layer 73 (the voltage developed across a light-receiving element 91 provided in the self-aligning machine) is monitored. Then, the position in which the amount of light is maximum is determined as an alignment position (a position in which the core 72 and the optical element 82 are appropriate relative to each other). On the other hand, when the above-mentioned optical element 82 is a light-receiving element, the alignment is as follows. As shown in FIG. 13B, the second end surface 72b of the core 72 receives a constant amount of light (light emitted from a light-emitting element 92 provided in the self-aligning machine and transmitted through the lens portion 73b provided in the second end portion of the over cladding layer 73) H₂. While the position of the light-receiving element is changed relative to the first end surface 72a of the core 72, with the light H₂ emitted outwardly from the first end surface 72a of the core 72 through a first end portion 73a of the over cladding layer 73, the amount of light received by the light-receiving element (the voltage) is monitored. Then, the position in which the amount of light is maximum is determined as the alignment position.

The alignment using the above-mentioned self-aligning machine can be high-precision alignment, but requires labor and time and is therefore unsuited for mass production.

The assignee of the present application has proposed an optical sensor module capable of achieving alignment without equipment and labor as mentioned above, and has already applied for a patent (Japanese Patent Application No. 2009-237771, related to U.S. patent application Ser. No. 12/900,964). As shown in FIG. 14 which is a perspective view of a first end portion of the optical sensor module, this optical sensor module is configured such that, on the surface of an under cladding layer 41 of an optical waveguide unit W₁, a pair of protruding portions 44 of a generally U-shaped plan configuration for the positioning of the substrate unit and a pair of groove portions 43b for fitting engagement with the substrate unit are formed in respective appropriate positions relative to a light-transmitting and light-receiving end surface 42a of a core 42. In a substrate unit E₁, on the other hand, positioning plate portions 51a to be positioned in respective slit portions (inside portions of the generally U-shaped con figuration) 44a of the protruding portions 44 of the above-mentioned optical waveguide unit W₁ and fitting plate portions 51b for fitting engagement with the respective groove portions 43b of the above-mentioned optical waveguide unit W₁ are formed in respective appropriate positions relative to an optical element 58. Then, the positioning plate portions 51a of the substrate unit E₁ are positioned in the respective slit portions 44a of the protruding portions 44 having the generally U-shaped plan configuration of the optical waveguide unit W₁, and the fitting plate portions 51b of the substrate unit E₁ are brought into fitting engagement with the respective groove portions 43b of the optical waveguide unit W₁. This couples the optical waveguide unit W₁ and the substrate unit E₁ together to provide an automatically aligned optical sensor module. In FIG. 14, the reference numeral 40 designates a sheet material, 43 designates an over cladding layer, 45 designates a through hole, and 51 designates a shaping substrate provided with the above-mentioned positioning plate portions 51a and the fitting plate portions 51b.

In this manner, the above-mentioned method al ready applied by the assignee of the present application is capable of automatically bringing the core 42 of the optical waveguide unit W₁ and the optical element 58 of the substrate unit E₁ into alignment with each other without any alignment operation. Because the need for the time-consuming alignment operation is eliminated, this method allows the mass production of optical sensor modules and is excellent in productivity.

However, it has s been found that the above-mentioned method still has room for improvement in positioning accuracy (alignment accuracy) of the substrate unit when the protruding portions 44 for the positioning of the substrate unit has a height less than 50 μm. Specifically, when the optical waveguide unit W₁ and the substrate unit E₁ are coupled together, as shown in FIG. 15A, the lower end edge of each of the positioning plate portions 51a of the substrate unit E₁ is in abutment with the surface of the under cladding layer 41, and a lower portion of a side end edge of each of the positioning plate portions 51a is in abutment with a vertical wall at the inner end of each of the protruding portions 44. The lower and side end edges of the above-mentioned positioning plate portions 51a are formed by etching for reasons of production. However, when the corner defined by the lower end edge and the lower portion of the side end edge is formed by etching, the corner is rounded in some cases, as shown in FIG. 15B which is an enlarged view of the corner. The rounded portion extends from the lower end edge of each of the positioning plate portions 51a to a vertical position as high as 50 μm. For this reason, when the height of the protruding portions (the height of the vertical wall) is less than 50 μm as mentioned earlier, it is impossible to bring the lower portion of the side end edge of each of the positioning plate portions 51a into abutment with the vertical wall at the inner end of each of the protruding portions 44, as shown in FIG. 15C. This reduces the positioning accuracy (the alignment accuracy) of the substrate unit.

In view of the foregoing, it is an object of the present invention to provide a method of manufacturing an optical sensor module which eliminates the need for the operation of alignment between a core in an optical waveguide unit and an optical element in a substrate unit and which does not reduce the accuracy of alignment if protruding portions have a thickness less than 50 μm, and an optical sensor module obtained thereby.

### SUMMARY OF THE INVENTION

To accomplish the above-mentioned object, a first aspect of the present invention is intended for a method of manufacturing an optical sensor module with a substrate unit in orthogonal relation to an optical waveguide unit. The method comprises the steps of: preparing an optical waveguide unit including an under cladding layer, and protruding portions having vertical walls for the positioning of a substrate unit, the protruding portions being formed on a surface portion of the under cladding layer lying in an appropriate position for the transmission and reception of light relative to a light-transmitting and light-receiving end portion of a core; preparing a substrate unit including an optical element mounted therein, and positioning plate portions formed by etching, the positioning plate portions having respective lower end edges and respective corners, the positioning plate portions being positioned by the placement of the lower end edges thereof on the surface of the under cladding layer and by the abutment of the corners thereof against the vertical walls of the protruding portions so that the optical element is in an appropriate position relative to the light-transmitting and light-receiving end portion of the core; and placing the substrate unit in orthogonal relation to the optical waveguide unit, and positioning the positioning plate portions of the substrate unit as mentioned above relative to the under cladding layer and the protruding portions of the optical waveguide unit, thereby positioning and fixing the substrate unit to the optical waveguide unit, wherein, in the optical waveguide unit, the vertical walls of the protruding portions for the positioning of the substrate unit have a height less than 50 μm, and wherein, in the substrate unit, each of the corners of the positioning plate portions has at least a portion formed as a positioning member made of the same material as an interconnecting metal layer of the substrate unit, whereby the corners become substantially right-angled corners.

A second aspect of the present invention is intended for an optical sensor module comprising: an optical waveguide unit including an under cladding layer, and protruding portions having vertical walls for the positioning of a substrate unit, the protruding portions being formed on a surface portion of the under cladding layer lying in an appropriate position for the transmission and reception of light relative to a light-transmitting and light-receiving end portion of a core; and a substrate unit including an optical element mounted therein, and positioning plate portions formed by etching, the positioning plate portions having respective lower end edges and respective corners, the positioning plate portions being positioned by the placement of the lower end edges thereof on the surface of the under cladding layer and by the abutment of the corners thereof against the vertical walls of the protruding portions so that the optical element is in an appropriate position relative to the light-transmitting and light-receiving end portion of the core, wherein the substrate unit is placed in orthogonal relation to the optical waveguide unit, and the positioning plate portions of the substrate unit are positioned as mentioned above relative to the under cladding layer and the protruding portions of the optical waveguide unit, whereby the substrate unit is positioned and fixed to the optical waveguide unit, wherein, in the optical waveguide unit, the vertical walls of the protruding portions for the positioning of the substrate unit have a height less than 50 μm, and wherein, in the substrate unit, each of the corners of the positioning plate portions has at least a portion formed as a positioning member made of the same material as an interconnecting metal layer of the substrate unit, whereby the corners become substantially right-angled corners.

The present inventor has made studies to achieve high alignment accuracy even when the protruding portions have a height less than 50 μm in the optical sensor module already applied for a patent (Japanese Patent Application No. 2009-237771, related to U.S. patent application Ser. No. 12/900,964) which eliminates the need for the operation of alignment between the core in the optical waveguide unit and the optical element in the substrate unit. As a result, the present inventor has found that the corners of the positioning plate portions of the substrate unit for abutment with the vertical walls of the above-mentioned protruding portions are not rounded when the corners are defined by the positioning members made of the same material as the interconnecting metal layer for use in the substrate unit. Thus, the present inventor has found that, if the vertical walls of the protruding portions have a height less than 50 μm, the corners of the above-mentioned positioning members are brought into abutment with the vertical walls of the protruding portions with reliability, whereby the alignment accuracy is made higher. Hence, the present inventor has attained the present invention.

According to the present invention, the term “substantially right-angled” corners of the positioning members means that the corners are not rounded or are extremely slightly rounded so as to be able to sufficiently abut against the vertical walls of the protruding portions having the height less than 50 μm.

In the method of manufacturing an optical sensor module according to the present invention, each of the corners of the positioning plate portions of the substrate unit for abutment with the vertical walls of the protruding portions of the optical waveguide unit has at least a portion formed as the positioning member made of the same material as an interconnecting metal layer of the substrate unit, whereby the corners become substantially right-angled corners. Thus, if the vertical walls of the protruding portions have a height less than 50 μm, the corners of the above-mentioned positioning members are brought into abutment with the vertical walls of the protruding portions with reliability. That is, the substrate unit is appropriately positioned relative to the optical waveguide unit, whereby appropriate alignment is automatically kept therebetween. This eliminates the need for the time-consuming alignment operation to allow the mass production of optical sensor modules.

In particular, when the positioning members are formed in an appropriate position relative to an optical element mounting pad by a photolithographic process using a single photomask at the same time that the optical element mounting pad constituting the interconnecting metal layer is formed, the optical element mounted on the above-mentioned optical element mounting pad and the above-mentioned positioning members are positioned relative to each other with high precision. Thus, high-precision alignment is achieved when the substrate unit is positioned relative to the optical waveguide unit.

Also, when portions of the respective positioning members to be placed on the under cladding layer are bent prior to the positioning of the substrate unit relative to the optical waveguide unit, the rigidity of the above-mentioned positioning members themselves is increased. This prevents the positioning members from buckling or breaking when the corners of the above-mentioned positioning members are brought into abutment with the protruding portions to consequently achieve the high-precision alignment.

Further, when the protruding portions of the optical waveguide unit are formed to have a generally U-shaped plan configuration, the ease of the positioning of the protruding portions and the positioning plate portions relative to each other allows more excellent productivity.

Also, when groove portions for fitting engagement with the substrate unit are formed in an over cladding layer of the optical waveguide unit, the groove portions extending in a direction of the thickness of the over cladding layer, the groove portions being configured to make the substrate unit orthogonal to the optical waveguide unit and to guide the substrate unit in an appropriate condition, the groove portions having a width decreasing gradually in a downward direction from the upper surface of the over cladding layer, and when the protruding portions of the optical waveguide unit are formed to have a generally U-shaped plan configuration, and have generally U-shaped opening portions, respectively, having a width decreasing gradually in an inward direction from the opening end thereof, then the guide further facilitates the positioning of the groove portions and the fitting plate portions relative to each other and the positioning of the protruding portions and the positioning members relative to each other. This further improves the productivity.

The optical sensor module according to the present invention is obtained by the above-mentioned manufacturing method. Thus, the positioning of the optical waveguide unit and the substrate unit relative to each other is accomplished by bringing the corners of the positioning members of the substrate unit into abutment with the vertical walls of the protruding portions of the optical waveguide unit. The optical waveguide unit is made thinner because the vertical walls of the above-mentioned protruding portions have a height less than 50 μm.

In particular, when the positioning members are formed in an appropriate position relative to an optical element mounting pad constituting the interconnecting metal layer, the optical element mounted on the above-mentioned optical element mounting pad and the above-mentioned positioning members are appropriately positioned relative to each other. Thus, the optical sensor module according to the present invention in which the substrate unit is positioned relative to the optical waveguide unit is aligned with high precision.

Also, when portions of the respective positioning members to be placed on the under cladding layer are bent, the rigidity of the positioning members themselves is increased. This prevents the positioning members from buckling or breaking if impacts, vibrations and the like are applied to the optical sensor module according to the present invention, with the above-mentioned positioning members held in abutment with the protruding portions. As a result, no misregistration of the substrate unit occurs, and the high-precision alignment is maintained.

Further, when the protruding portions of the optical waveguide unit are formed to have a generally U-shaped plan configuration, the optical sensor module aligned with high precision is provided with a simple positioning structure.

Also, the optical sensor module aligned with high precision is provided with a simple positioning structure, when groove portions for fitting engagement with the substrate unit are formed in an over cladding layer of the optical waveguide unit, the groove portions extending in a direction of the thickness of the over cladding layer, the groove portions being configured to make the substrate unit orthogonal to the optical waveguide unit and to guide the substrate unit in an appropriate condition, the groove portions having a width decreasing gradually in a downward direction from the upper surface of the over cladding layer, and when the protruding portions of the optical waveguide unit are formed to have a generally U-shaped plan configuration, and have generally U-shaped opening portions, respectively, having a width decreasing gradually in an inward direction from the opening end thereof.

### BRIEF DESCRIPTION OF THE DRAWINGS

FIG. 1 is a perspective view schematically showing one end portion of an optical sensor module according to a first embodiment of the present invention.

FIG. 2 is a front view in section schematically showing a positioning member of a positioning plate portion and a protruding portion as positioned relative to each other.

FIG. 3 is a perspective view schematically showing one end portion of an optical waveguide unit of the optical sensor module.

FIG. 4 is a perspective view schematically showing a substrate unit of the optical sensor module.

FIG. 5A is a view schematically showing part of the positioning member of the substrate unit as seen in the direction of the arrow A of FIG. 4.

FIG. 5B is a sectional view schematically showing the part of FIG. 5A taken along the line B-B of FIG. 4.

FIGS. 6A to 6C are illustrations schematically showing the steps of forming an under cladding layer, a core, and the protruding portion for the positioning of the substrate unit in the optical waveguide unit.

FIG. 7A is a perspective view schematically showing a molding die for use in the formation of an over cladding layer in the optical waveguide unit.

FIGS. 7B to 7D are illustrations schematically showing the steps of forming the over cladding layer.

FIGS. 8A to 8C are illustrations schematically showing the steps of producing the substrate unit.

FIGS. 9A to 9C are illustrations schematically showing the steps of producing the substrate unit following FIGS. 8A to 8C.

FIG. 10 is a perspective view schematically showing one end portion of an optical sensor module according to a second embodiment of the present invention.

FIG. 11 is a plan view schematically showing a detection means for a touch panel using the optical sensor module.

FIG. 12A is a plan view schematically showing a groove portion according to Inventive Examples 2 and 4.

FIG. 12B is a sectional view taken along the line C-C of FIG. 12A.

FIG. 12C is a plan view schematically showing protruding portions according to Inventive Examples 2 and 4.

FIGS. 13A and 13B are illustrations schematically showing a conventional method of alignment in an optical sensor module.

FIG. 14 is a perspective view schematically showing one end portion of an optical sensor module disclosed in a prior application of the assignee of the present application.

FIG. 15A is a front view in section schematically showing a positioning plate portion and a protruding portion as positioned relative to each other in the optical sensor module disclosed in the prior application of the assignee of the present application.

FIG. 15B is an enlarged view of a corner of the positioning plate portion.

FIG. 15C is a front view in section schematically showing the positioning when the protruding portion has a height less than 50 μm.

### DETAILED DESCRIPTION

Next, embodiments according to the present invention will now be described in detail with reference to the drawings.

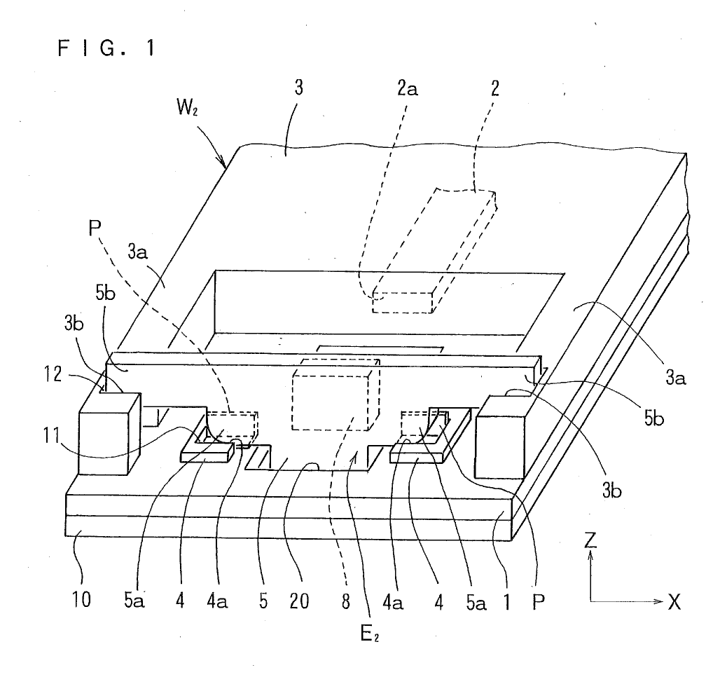

FIG. 1 is a perspective view schematically showing a first end portion of an optical sensor module according to a first embodiment of the present invention. This optical sensor module is configured such that an optical waveguide unit W₂ and a substrate unit E₂ are produced individually and then integrated together in orthogonal relation to each other to achieve automatic alignment therebetween.

Specifically, the optical waveguide unit W₂ comprises a pair of protruding portions 4 of a generally U-shaped plan configuration having vertical walls for the positioning of the substrate unit. The protruding portions 4 are formed on a surface portion of an under cladding layer 1 that lies in an appropriate position for the transmission and reception of light relative to a light-transmitting and light-receiving end surface 2a of a core 2. The height of the protruding portions 4 (the height of the vertical walls) are less than 50 μm. The above-mentioned optical waveguide unit W₂ further comprises an over cladding layer 3 including extensions 3a formed on opposite sides (the left-hand and right-hand sides as seen in FIG. 1) where the core 2 is absent, and a pair of groove portions 3b for fitting engagement with the substrate unit. The groove portions 3b are formed in the extensions 3a, respectively, with the openings of the respective groove portions 3b in face-to-face relation with each other.

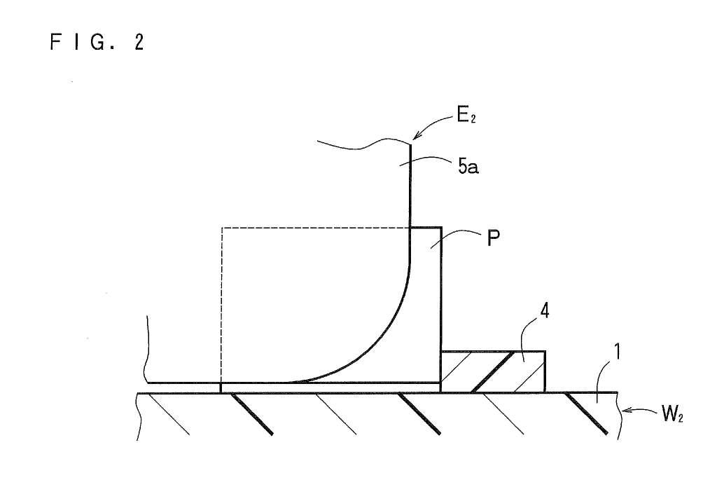

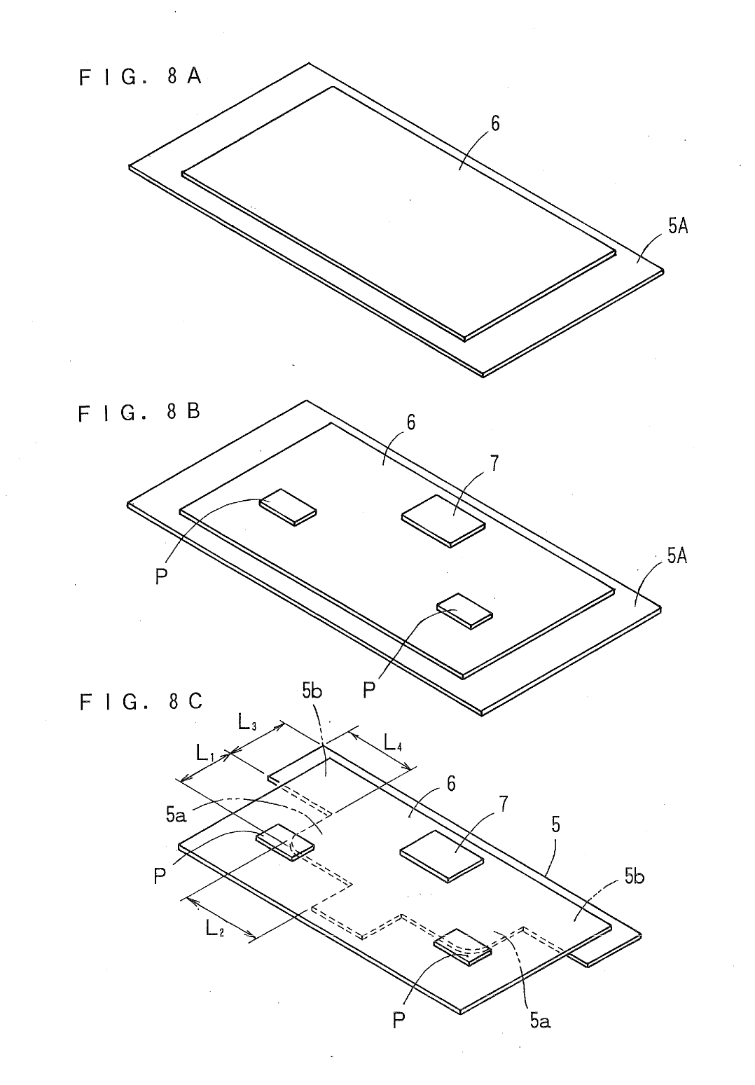

The substrate unit E₂ includes positioning plate portions 5a to be positioned in respective slit portions (inside portions of the generally U-shaped con figuration) 4a of the protruding portions 4 having the generally U-shaped plan configuration of the above-mentioned optical waveguide unit W₂. Each of the positioning plate portions 5a has a substantially right-angled corner defined by a positioning member P formed at the same time as an interconnecting metal layer such as an optical element mounting pad 7 (with reference to FIG. 8B) formed in the substrate unit E₂ and made of the same material as the interconnecting metal layer. With the positioning member P and a corresponding one of the above-mentioned protruding portions 4 positioned relative to each other, as shown on an enlarged scale in FIG. 2, the lower end edge of the above-mentioned positioning member P is placed on a surface of the above-mentioned under cladding layer 1, and a side end edge of the positioning member P is in abutment with a vertical wall of the above-mentioned corresponding protruding portion 4. This allows an optical element 8 in the above-mentioned substrate unit E₂ to be positioned with high precision relative to the light-transmitting and light-receiving end surface 2a of the above-mentioned core 2 and to be in high-precision alignment therewith. As shown in FIG. 1, the above-mentioned substrate unit E₂ further includes fitting plate portions 5b for fitting engagement with the respective groove portions 3b of the above-mentioned optical waveguide unit W₂. In this embodiment, a lower end edge portion of the positioning member P is bent along the lower end thereof, and the bent portion is placed on the surface of the above-mentioned under cladding layer 1.

When the optical waveguide unit W₂ and the substrate unit E₂ are integrated together to constitute an optical sensor module, the corners of the respective positioning members P are positionable relative to the under cladding layer 1 and the protruding portions 4 of the optical waveguide unit W₂ because the corners of the respective positioning members P are substantially right-angled even if the vertical walls of the protruding portions 4 have a height less than 50 μm, as mentioned above. This allows the end surface 2a of the core 2 and the optical element 8 to be positioned with high precision and are in high-precision alignment with each other. The above-mentioned high-precision alignment is maintained by the fitting engagement between the groove portions 3b of the optical waveguide unit W₂ and the fitting plate portions 5b of the substrate unit E₂.

In FIG. 1, clearance 11 is shown as created between the protruding portions 4 having the generally U-shaped plan configuration of the optical waveguide unit W₂ and the positioned members P of the substrate unit E₂, and clearance 12 is shown as created between the groove portions 3b of the optical waveguide unit W₂ and the fitting plate portions 5b of the substrate unit E₂, for the sake of easier understanding of the figures. In reality, however, the clearances 11 and 12 are almost zero. In FIG. 1, the reference numeral 5 designates a shaping substrate, 10 designates a sheet material, and 20 designates a through hole.

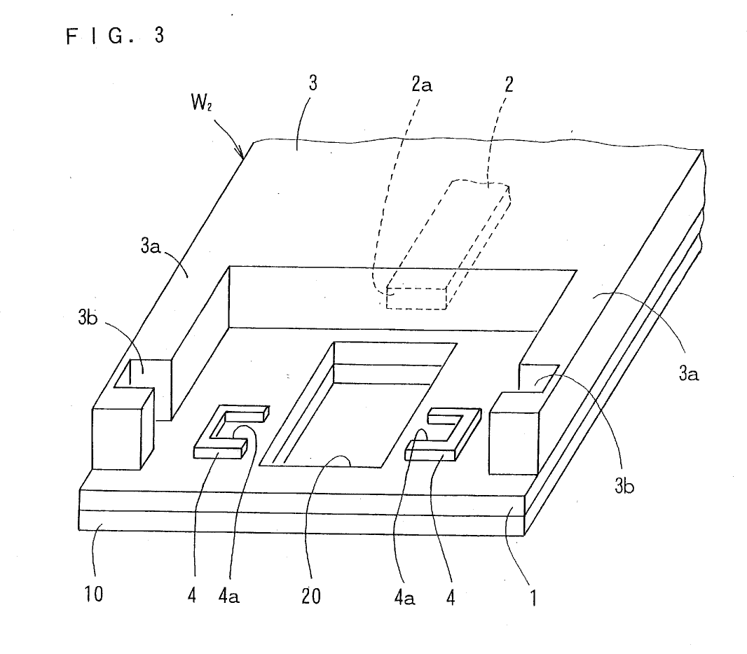

More specifically, the above-mentioned optical waveguide unit W₂, a first end portion of which is shown in perspective view in FIG. 3, is formed on a surface of the sheet material 10, and includes the under cladding layer 1, the core 2 for an optical path formed linearly in a predetermined pattern on the surface of this under cladding layer 1, the pair of protruding portions 4 having the generally U-shaped plan configuration and formed on the surface of this under cladding layer 1, and the over cladding layer 3 formed on the surface of the above-mentioned under cladding layer 1 so as to cover the core 2. The above-mentioned pair of protruding portions 4 having the generally U-shaped plan configuration are formed in positions some distance away from the end surface 2a of the core 2, with their openings of the generally U-shaped configuration in face-to-face relation with each other. The direction in which the openings of the respective protruding portions 4 are in face-to-face relation with each other (the horizontal direction as seen in FIG. 3) is perpendicular to the axial direction of the core 2. In the first end portion (the lower end portion as seen in FIG. 3) of the optical waveguide unit W₁, portions (left-hand and right-hand portions as seen in FIG. 3) of the over cladding layer 3 where the core 2 is absent are axially (obliquely downwardly to the left as seen in FIG. 3) extended. The pair of groove portions 3b for fitting engagement with the substrate unit are formed in the extensions 3a, respectively, with the openings of the respective groove portions 3b in face-to-face relation with each other. The groove portions 3b extend across the thickness of the over cladding layer 3 so that the surface of the under cladding layer 1 serves as the lower end surfaces of the groove portions 3b.

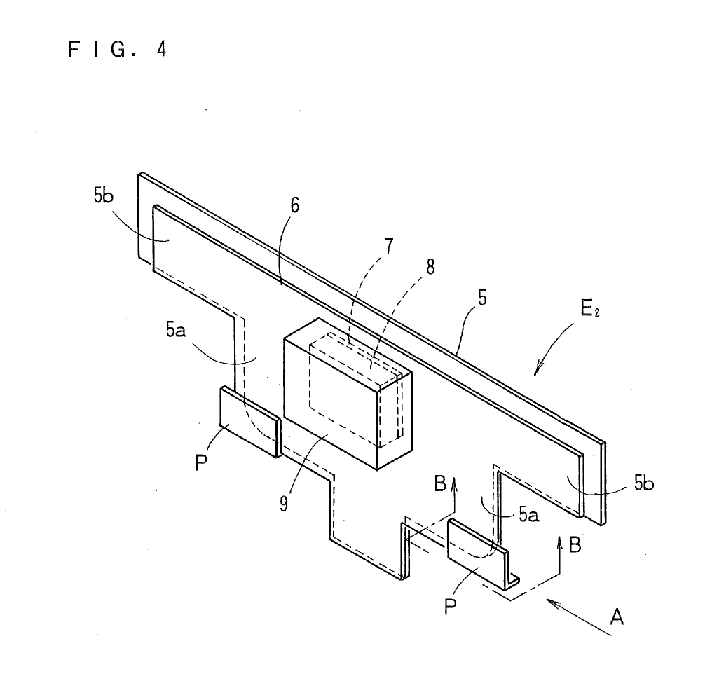

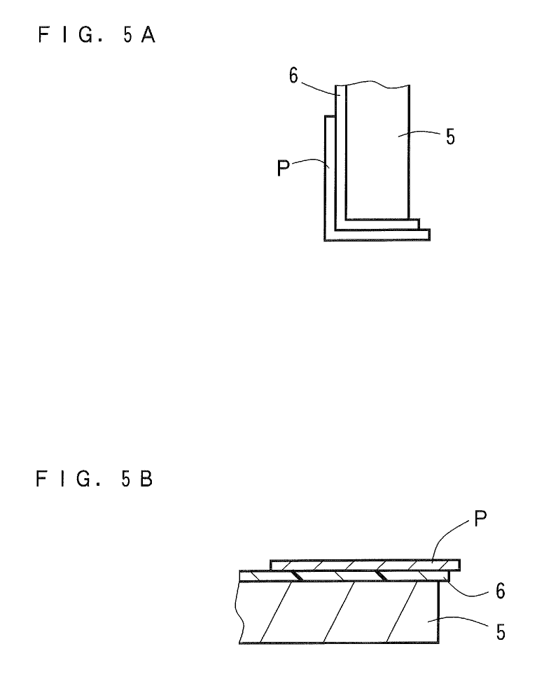

On the other hand, the above-mentioned substrate unit E₂ includes the shaping substrate 5, an insulation layer 6, the optical element mounting pad 7, the positioning members P, the optical element 8, and a transparent resin layer 9, as shown in perspective view in FIG. 4. The above-mentioned substrate unit E₂ is configured such that the positioning plate portions 5a for the positioning in the above-mentioned pair of protruding portions 4 protrude both leftwardly and rightwardly, and that the fitting plate portions 5b for fitting engagement with the above-mentioned groove portions 3b protrude both leftwardly and rightwardly. The above-mentioned shaping substrate 5 is shaped to correspond to the substrate unit E₂. The above-mentioned insulation layer 6 is formed on a predetermined portion of a surface of the above-mentioned shaping substrate 5. Portions of the insulation layer 6 which correspond to the above-mentioned positioning plate portions 5a extend out of the end edges thereof (with reference to FIGS. 5A and 5B). The above-mentioned optical element mounting pad 7 is formed substantially on a central portion of a surface of the above-mentioned insulation layer 6. The above-mentioned positioning members P are formed at respective corners of portions of the above-mentioned insulation layer 6 which correspond to the above-mentioned positioning plate portions 5a, and extend out of the end edges of the above-mentioned insulation layer 6 (with reference to FIGS. 5A and 5B). In this embodiment, portions of the positioning members P which extend out of the lower end edges of the shaping substrate 5, as well as portions of the insulation layer 6 on the back surface thereof, are bent along the lower end edge of the shaping substrate 5 toward the shaping substrate (with reference to FIG. 5A). The above-mentioned optical element 8 is mounted on the optical element mounting pad 7. The above-mentioned transparent resin layer 9 is formed so as to seal the above-mentioned optical element 8. In such a substrate unit E₂, the above-mentioned positioning plate portions 5a, the fitting plate portions 5b, and the above-mentioned positioning members P are formed in appropriate positions relative to the above-mentioned optical element mounting pad 7. The above-mentioned optical element 8 includes a light-emitting section or a light-receiving section formed on a surface of the optical element 8. An electric interconnect line (not shown) for connection to the optical element mounting pad 7 is formed on the surface of the above-mentioned insulation layer 6.

In the optical sensor module in which the above-mentioned optical waveguide unit W₂ and the substrate unit E₂ are integrated together, as shown in FIG. 1 (as mentioned earlier), the positioning plate portions 5a of the above-mentioned substrate unit E₂ are positioned in the slit portions 4a of the pair of protruding portions 4 having the generally U-shaped plan configuration of the above-mentioned optical waveguide unit W₂. Additionally, the lower end edges of the respective positioning members P defining the corners of the positioning plate portions 5a are placed on the surface of the under cladding layer 1, and side end edges of the respective positioning members P are in abutment with vertical walls of the above-mentioned protruding portions 4. Further, the fitting plate portions 5b of the above-mentioned substrate unit E₂ are in fitting engagement with the pair of groove portions 3b of the above-mentioned optical waveguide unit W₂.

Specifically, in the above-mentioned optical sensor module, the above-mentioned optical element 8 is appropriately positioned in a horizontal direction (along the X-axis) as seen in FIG. 1 relative to the end surface 2a of the core 2 by the abutment of the side end edges of the above-mentioned positioning members P against the vertical walls of the above-mentioned pair of protruding portions 4. Also, the above-mentioned optical element 8 is appropriately positioned in a vertical direction (along the Z-axis) as seen in FIG. 1 relative to the end surface 2a of the core 2 by the placement of the lower end edges of the above-mentioned positioning members P on the surface of the under cladding layer 1. That is, the end surface 2a of the core 2 and the optical element 8 are automatically kept in high-precision alignment with each other by the above-mentioned integration.

In this embodiment, the rectangular through hole 20 is formed in a portion of a laminate comprised of the sheet material 10 and the under cladding layer 1 corresponding to the above-mentioned substrate unit E₂, as shown in FIG. 1. A portion of the substrate unit E₂ protrudes from the back surface of the above-mentioned sheet material 10 through the through hole 20. The protruding portion of the substrate unit E₂ is connected on the back side of the sheet material 10 to, for example, a motherboard (not shown) and the like for the sending and the like of a signal to the optical element 8.

In the above-mentioned optical sensor module, a light beam is propagated in a manner to be described below. Specifically, when the above-mentioned optical element 8 is, for example, a light-emitting element, the light beam emitted from the light-emitting section of the optical element 8 passes through the transparent resin layer 9 and through a first end portion of the over cladding layer 3, and thereafter enters the core 2 through the first end surface 2a of the core 2. Then, the light beam travels through the interior of the core 2 in the axial direction. Then, the light beam exits from a second end surface (not shown) of the core 2.

On the other hand, when the above-mentioned optical element 8 is a light-receiving element, a light beam travels in a direction opposite from that described above. Specifically, the light beam enters the core 2 through the second end surface (not shown) of the core 2, and travels through the interior of the core 2 in the axial direction. Then, the light beam passes through the first end surface 2a of the core 2, and passes through and exits from the first end portion of the over cladding layer 3. The light beam then passes through the transparent resin layer 9, and is received by the light-receiving section of the above-mentioned optical element 8.

The above-mentioned optical sensor module is manufactured by undergoing the process steps (1) to (3) to be described below.

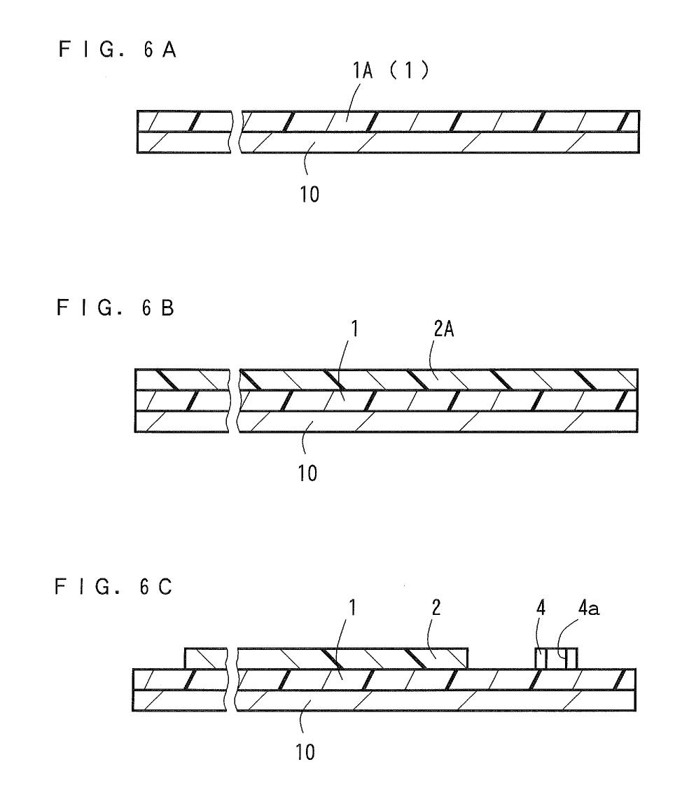

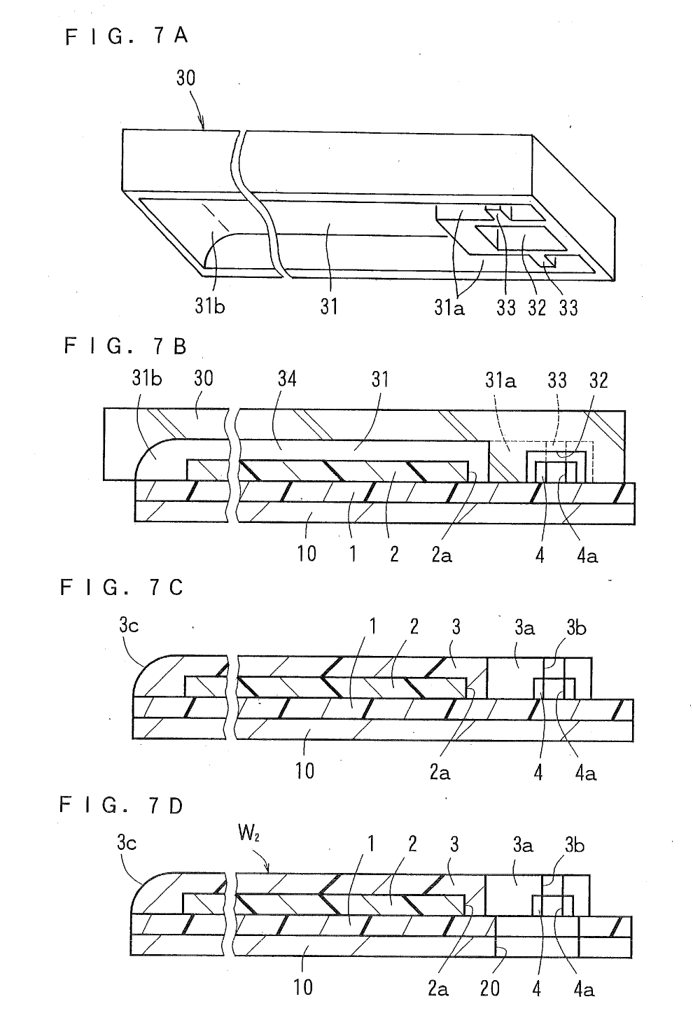

(1) The step of producing the above-mentioned optical waveguide unit W₂ (with reference to FIGS. 6A to 6C, and FIGS. 7A to 7D).

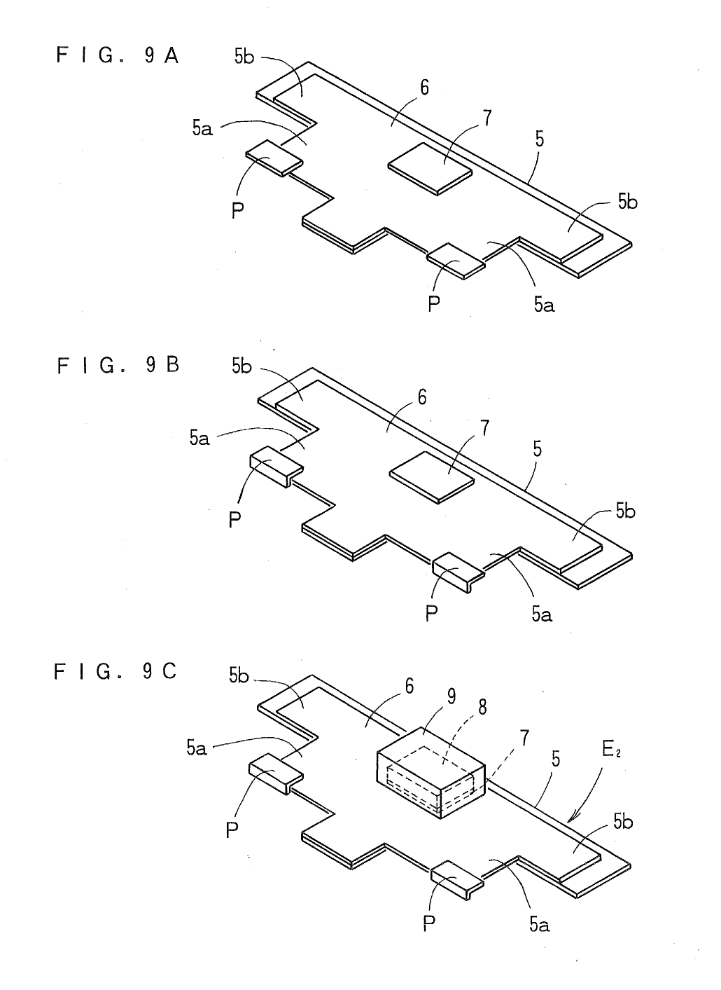

(2) The step of producing the above-mentioned substrate unit E₂ (with reference to FIGS. 8A to 8C, and FIGS. 9A to 9C).

(3) The step of coupling the above-mentioned substrate unit E₂ to the above-mentioned optical waveguide unit W₂.

### Step of Producing Optical Waveguide Unit W₂

The above-mentioned step (1) of producing the optical waveguide unit W₂ will be described. First, the sheet material 10 of a flat shape (with reference to FIG. 6A) for use in the formation of the under cladding layer 1 is prepared. Examples of a material for the formation of the sheet material 10 include metal, resin, and the like. In particular, stainless steel is preferable. This is because the sheet material 10 made of stainless steel is excellent in resistance to thermal expansion and contraction so that various dimensions thereof are maintained substantially at their design values in the course of the manufacture of the above-mentioned optical waveguide unit W₂. The thickness of the sheet material 10 is, for example, in the range of 10 to 100 μm, and preferably in the range of 20 to 70 μm from an economic standpoint.

Then, as shown in FIG. 6A, a varnish prepared by dissolving a photosensitive resin such as a photosensitive epoxy resin and the like for the formation of the under cladding layer in a solvent is applied to the surface of the above-mentioned sheet material 10. Thereafter, a heating treatment (at 50 to 120° C. for approximately 10 to 30 minutes) is performed on the varnish, as required, to dry the varnish, thereby forming a photosensitive resin layer 1A for the formation of the under cladding layer 1. Then, the photosensitive resin layer 1A is exposed to irradiation light such as ultraviolet light and the like. This causes the photosensitive resin layer 1A to be formed into the under cladding layer 1. The thickness of the under cladding layer 1 is typically in the range of 5 to 100 μm.

Next, as shown in FIG. 6B, a photosensitive resin layer 2A for the formation of the core and the protruding portions having the generally U-shaped plan configuration is formed on the surface of the above-mentioned under cladding layer 1 in a manner similar to the process for forming the above-mentioned photosensitive resin layer 1A for the formation of the under cladding layer. Then, the above-mentioned photosensitive resin layer 2A is exposed to irradiation light through a photomask formed with an opening pattern corresponding to the pattern of the core 2 and the protruding portions 4 having the generally U-shaped plan configuration in a position determined with high precision. Next, a heating treatment is performed. Thereafter, development is performed using a developing solution to dissolve away unexposed portions of the above-mentioned photosensitive resin layer 2A, as shown in FIG. 6C, thereby forming the remaining photosensitive resin layer 2A into the pattern of the core 2 and the protruding portions 4 having the generally U-shaped plan configuration. As described above, the protruding portions 4 having the generally U-shaped plan configuration are formed at the same time as the core 2 by a photolithographic process using the single photomask. For this reason, the protruding portions 4 are formed in an appropriate shape in a position determined with high precision relative to the light-transmitting and light-receiving end surface 2a of the core 2.

The height of the above-mentioned core 2 and the protruding portions 4 having the generally U-shaped plan configuration is less than 50 μm, and the lower limit of the height is typically 20 μm. The width of the core 2 is typically in the range of 5 to 60 μm. The slit width of the slit portions 4a of the protruding portions 4 having the generally U-shaped plan configuration is set at a value slightly greater than the thickness of the positioning plate portions 5a of the substrate unit E₂ to be positioned in the slit portions 4a, and is typically in the range of 20 to 200 μm. The width of the lines forming the generally U-shaped plan configuration is typically in the range of 10 to 2000 μm. The pair of protruding portions 4 are equally spaced apart from the end surface 2a of the core 2. A distance between a line connecting the pair of protruding portions 4 and the end surface 2a of the core 2 is typically in the range of 0.3 to 1.5 mm, depending on the size of the optical element and the like. A distance between the pair of protruding portions 4 is typically in the range of 3 to 20 mm.

An example of the material for the formation of the above-mentioned core 2 and the protruding portions 4 having the generally U-shaped plan configuration includes a photosensitive resin similar to that for the above-mentioned under cladding layer 1, and the material used herein has a refractive index greater than that of the material for the formation of the above-mentioned under cladding layer 1 and the over cladding layer 3 (with reference to FIG. 7B). The adjustment of this refractive index may be made, for example, by adjusting the selection of the types of the materials for the formation of the above-mentioned under cladding layer 1, the core 2 and the over cladding layer 3, and the composition ratio thereof.

Next, a molding die 30 (with reference to FIG. 7A) is prepared. This molding die 30 is used to die-mold the over cladding layer 3 (with reference to FIG. 7C) and the extensions 3a of the over cladding layer 3 which have the groove portions 3b (with reference to FIG. 7C) for fitting engagement with the substrate unit at the same time. The lower surface of this molding die 30 is formed with a first recessed portion 31 having a die surface complementary in shape to the above-mentioned over cladding layer 3, and a second recessed portion 32 in which the protruding portions 4 having the generally U-shaped plan configuration are to be inserted, as shown in FIG. 7A that is a perspective view as viewed from below. The above-mentioned first recessed portion 31 includes portions 31a for the formation of the above-mentioned extensions 3a. In this embodiment, the first recessed portion 31 further includes a portion 31b for the formation of a lens portion 3c (with reference to FIG. 7C). Ridges 33 for the molding of the groove portions 3b for fitting engagement with the above-mentioned substrate unit are formed in the portions 31a for the formation of the above-mentioned extensions. Also, the upper surface of the above-mentioned molding die 30 is formed with alignment marks (not shown) for the purpose of alignment with the end surface 2a (the right-hand end surface as seen in FIG. 7B) of the core 2 for the appropriate positioning of the molding die 30 when in use. The above-mentioned first recessed portion 31 and the ridges 33 are formed in appropriate positions with respect to the alignment marks.

Thus, when the above-mentioned molding die 30 is set after the alignment marks of the above-mentioned molding die 30 are aligned with the end surface 2a of the core 2, and is used to perform the molding in that state, the over cladding layer 3 and the groove portions 3b for fitting engagement with the substrate unit are allowed to be die-molded at the same time in appropriate positions with respect to the end surface 2a of the core 2. Also, the above-mentioned molding die 30 is set by bringing the lower surface of the molding die 30 into intimate contact with the surface of the under cladding layer 1, whereby the space surrounded by the die surfaces of the above-mentioned first recessed portion 31, the surface of the under cladding layer 1 and the surface of the core 2 is defined as a mold space 34 (with reference to FIG. 7B). Further, the above-mentioned molding die 30 is further formed with an inlet (not shown) for the injection of a resin for the formation of the over cladding layer therethrough into the above-mentioned mold space 34, the inlet being in communication with the above-mentioned first recessed portion 31.

An example of the above-mentioned resin for the formation of the over cladding layer includes a photosensitive resin similar to that for the above-mentioned under cladding layer 1. In this case, it is necessary that the photosensitive resin that fills the above-mentioned mold space 34 be exposed to irradiation light such as ultraviolet light and the like directed through the above-mentioned molding die 30. For this reason, a molding die made of a material permeable to the irradiation light (for example, a molding die made of quartz) is used as the above-mentioned molding die 30. It should be noted that a thermosetting resin may be used as the resin for the formation of the over cladding layer. In this case, the above-mentioned molding die 30 may have any degree of transparency. For example, a molding die made of metal or quartz is used as the above-mentioned molding die 30.

Then, as shown in FIG. 7B, the alignment marks of the molding die 30 are aligned with the end surface 2a of the above-mentioned core 2 so that the entire molding die 30 is appropriately positioned. In that state, the lower surface of the molding die 30 is brought into intimate contact with the surface of the under cladding layer 1. In this state, the protruding portions 4 having the generally U-shaped plan configuration are inserted in the second recessed portion 32 of the molding die 30. Then, the resin for the formation of the over cladding layer is injected through the inlet formed in the above-mentioned molding die 30 into the mold space 34 surrounded by the die surfaces of the above-mentioned first recessed portion 31 and the ridges 33, the surface of the under cladding layer 1 and the surface of the core 2 to fill the above-mentioned mold space 34 therewith. Next, when the resin is the photosensitive resin, exposure to irradiation light such as ultraviolet light is performed through the above-mentioned molding die 30, and thereafter a heating treatment is performed. When the above-mentioned resin is the thermosetting resin, a heating treatment is performed. This hardens the above-mentioned resin for the formation of the over cladding layer to form the groove portions 3b for fitting engagement with the substrate unit (the extensions 3a of the over cladding layer 3) at the same time as the over cladding layer 3. When the under cladding layer 1 and the over cladding layer 3 are made of the same material, the under cladding layer 1 and the over cladding layer 3 are integrated together at the contact portions thereof. Then, the molding die 30 is removed. As shown in FIG. 7C, the over cladding layer 3 and the pair of groove portions 3b for fitting engagement with the substrate unit are provided.

The groove portions 3b for fitting engagement with the substrate unit are positioned in an appropriate location relative to the end surface 2a of the core 2 because the groove portions 3b are formed with respect to the end surface 2a of the core 2 by using the above-mentioned molding die 30, as mentioned earlier. Also, the lens portion 3c of the above-mentioned over cladding layer 3 is also positioned in an appropriate location. However, the substrate unit E₂ is positioned, as mentioned earlier, by the use of the above-mentioned protruding portions 4 having the generally U-shaped plan configuration, and the above-mentioned fitting portions 3b are provided to hold the above-mentioned substrate unit E₂. Thus, the production of the above-mentioned molding die 30 does not require a high level of machining accuracy. The costs of the molding die 30 are accordingly reduced.

The thickness of the above-mentioned over cladding layer 3 (the thickness as measured from the surface of the under cladding layer 1) is typically in the range of 0.5 to 3 mm. The size of the above-mentioned groove portions 3b for fitting engagement with the substrate unit is defined in corresponding relation to the size of the fitting plate portions 5b of the substrate unit E₂ for fitting engagement therewith. For example, the depth (the dimension along the X-axis as seen in FIG. 1) of the grooves is in the range of 1.0 to 5.0 mm, and the width of the grooves is in the range of 0.2 to 2.0 mm.

Thereafter, as shown in FIG. 7D, the through hole 20 for insertion of the substrate unit E₂ is formed in a portion of the laminate comprised of the sheet material 10 and the under cladding layer 1 lying between the pair of protruding portions 4 having the generally U-shaped plan configuration for the positioning of the above-mentioned substrate unit by using a puncher and the like. In this manner, the optical waveguide unit W₂ is provided which includes the under cladding layer 1, the core 2 and the over cladding layer 3 on the surface of the sheet material 10 and which is formed with the pair of protruding portions 4 having the generally U-shaped plan configuration for the positioning of the substrate unit and the pair of groove portions 3b for fitting engagement with the substrate unit. Thus, the above-mentioned step (1) of producing the optical waveguide unit W₂ is completed.

### Step of Producing Substrate Unit E₂

Next, the above-mentioned step (2) of producing the substrate unit E₂ will be described. First, a substrate 5A (with reference to FIG. 8A) serving as a base material for the above-mentioned shaping substrate 5 is prepared. Examples of the material for the formation of the substrate 5A include metal, resin and the like.

In particular, the substrate 5A made of stainless steel is preferable from the viewpoint of easy processibility and dimensional stability. The thickness of the above-mentioned substrate 5A is, for example, in the range of 0.02 to 0.1 mm.

Then, as shown in FIG. 8A, a varnish prepared by dissolving a photosensitive resin for the formation of the insulation layer such as a photosensitive polyimide resin and the like in a solvent is applied to a predetermined region of a surface of the above-mentioned substrate 5A. Thereafter, a heating treatment is performed on the varnish, as required, to dry the varnish, thereby forming a photosensitive resin layer for the formation of the insulation layer. Then, the photosensitive resin layer is exposed to irradiation light such as ultraviolet light and the like through a photomask. This causes the photosensitive resin layer to be formed into the insulation layer 6 having a predetermined shape. The thickness of the insulation layer 6 is typically in the range of 5 to 15 μm.

Next, as shown in FIG. 8B, the optical element mounting pad 7, the electric interconnect line (not shown) for connection to the optical element mounting pad 7, and the positioning members P all of which are made of the same material (the material of interconnecting metal layers) are formed on predetermined regions of the surface of the above-mentioned insulation layer 6. In this manner, the mounting pad 7, the electric interconnect line, and the positioning members P are inclusively referred to as the interconnecting metal layers according to the present invention. The formation of the mounting pad 7, the electric interconnect line, and the positioning members P is achieved, for example, in a manner to be described below. Specifically, a metal layer (having a thickness on the order of 60 to 260 nm) is initially formed on the surface of the above-mentioned insulation layer 6 by sputtering, electroless plating and the like. This metal layer becomes a seed layer (a layer serving as a basis material for the formation of an electroplated layer) for a subsequent electroplating process. Then, a dry film resist is affixed to the opposite surfaces of a laminate comprised of the above-mentioned substrate 5A, the insulation layer 6, and the seed layer. Thereafter, a photolithographic process using a single photomask is performed to form hole portions having the pattern of the above-mentioned mounting pad 7, the electric interconnect line, and the positioning members P at the same time in the dry film resist on the side where the above-mentioned seed layer is formed, so that surface portions of the above-mentioned seed layer are uncovered at the bottoms of the hole portions. Next, electroplating is performed to form an electroplated layer (having a thickness on the order of 5 to 20 μm) in a stacked manner on the surface portions of the above-mentioned seed layer uncovered at the bottoms of the above-mentioned hole portions. Then, the above-mentioned dry film resist is stripped away using an aqueous sodium hydroxide solution and the like. Thereafter, a seed layer portion on which the above-mentioned electroplated layer is not formed is removed by soft etching, so that a laminate portion comprised of the remaining electroplated layer and the underlying seed layer is formed into the mounting pad 7, the electric interconnect line, and the positioning members P. As described above, the positioning members P are formed at the same time as the mounting pad 7 by utilizing the photolithographic process using the single photomask. For this reason, the positioning members P are formed in an appropriate shape in a position determined with high precision relative to the mounting pad 7, and have substantially right-angled corners that are hardly rounded.

Then, as shown in FIG. 8C, the above-mentioned substrate 5A is etched so that portions corresponding to the positioning plate portions 5a and portions corresponding to the fitting plate portions 5b are formed in appropriate positions relative to the mounting pad 7, thereby providing the shaping substrate 5. The formation of this shaping substrate 5 is achieved, for example, in a manner to be described below. Specifically, the back surface of the above-mentioned substrate 5A is covered with a dry film resist. A photolithographic process is performed to leave portions of the dry film resist having an intended shape unremoved so that the positioning plate portions 5a and the fitting plate portions 5b are formed in the appropriate positions relative to the mounting pad 7. Then, uncovered portions of the substrate 5A except where the portions of the dry film resist are left unremoved are etched away by using an aqueous ferric chloride solution. This provides the portions corresponding to the positioning plate portions 5a, and the portions corresponding to the fitting plate portions 5b. Then, the above-mentioned dry film resist is stripped away using an aqueous sodium hydroxide solution and the like.

Corners of the portions corresponding to the positioning plate portions 5a of the above-mentioned shaping substrate 5, which are formed by etching, are rounded. The rounded portions extend from the lower end edges of the above-mentioned positioning plate portions 5a to a vertical position as high as 50 μm. The substantially right-angled corners of the above-mentioned positioning members P extend slightly out of the rounded corners of the above-mentioned positioning plate portions 5a.

The size of the above-mentioned positioning plate portions 5a is, for example, as follows: a vertical dimension L₁ in the range of 0.1 to 1.0 mm; and a horizontal dimension L₂ in the range of 1.0 to 5.0 mm. The size of the fitting plate portions 5b is, for example, as follows: a vertical dimension L₃ in the range of 0.5 to 2.0 mm; and a horizontal dimension L₄ gin the range of 1.0 to 5.0 mm.

Next, as shown in FIG. 9A, excess portions of the insulation layer 6 are etched away. This process is performed, for example, in a manner to be described below. Specifically, the back surface of the above-mentioned shaping substrate 5 and the back surface of portions of the insulation layer 6 which extend out of the shaping substrate 5 are covered with a dry film resist. Then, a photolithographic process is performed to leave portions of the dry film resist except where the excess portions of the insulation layer 6 are to be removed. Uncovered portions of the insulation layer 6 except where the portions of the dry film resist are left are etched away by using a polyimide etchant. Next, the above-mentioned dry film resist is stripped away using an aqueous sodium hydroxide solution and the like.

Further, as shown in FIG. 9B, the lower end edge portions of the above-mentioned positioning members P extending out of the lower end edges of the above-mentioned positioning plate portions 5a, respectively, together with portions of the insulation layer 6 on the back surface thereof are put against a plate member and the like, and are bent along the lower end edges of the positioning plate portions 5a toward the positioning plate portions 5a.

Then, as shown in FIG. 9C, the optical element 8 is mounted on the mounting pad 7, and thereafter the above-mentioned optical element 8 and its surrounding portion are sealed with a transparent resin by potting. The mounting of the above-mentioned optical element 8 is performed using a mounting machine after the optical element 8 is precisely positioned relative to the mounting pad 7 by using a positioning device such as a positioning camera and the like provided in the mounting machine. This provides the substrate unit E₂ including the shaping substrate 5, the insulation layer 6, the mounting pad 7, the positioning members P, the optical element 8, and the transparent resin layer 9. Thus, the above-mentioned step (2) of producing the substrate unit E₂ is completed. In the substrate unit E₂, the positioning members P of the positioning plate portions 5a, and the fitting plate portions 5b are formed with respect to the mounting pad 7, as mentioned earlier. Accordingly, the optical element 8 mounted on the mounting pad 7, and the positioning members P of the positioning plate portions 5a and the fitting plate portions 5b are in an appropriate positional relationship.

### Step of Coupling Optical Waveguide Unit W₂ and Substrate Unit E₂ Together

Next, the above-mentioned step (3) of coupling the optical waveguide unit W₂ and the substrate unit E₂ together will be described. Specifically, the surface (the light-emitting section or the light-receiving section) of the optical element 8 of the substrate unit E₂ (with reference to FIGS. 4 and 9C) is directed to face toward the end surface 2a of the core 2 of the optical waveguide unit W₂ (with reference to FIG. 3). In that state, the positioning plate portions 5a in the above-mentioned substrate unit E₂ are positioned in the slit portions 4a of the pair of protruding portions 4 having the generally U-shaped plan configuration in the optical waveguide unit W₂ for the positioning of the substrate unit. The lower end edges of the respective positioning members P defining the corners of the positioning plate portions 5a are placed on the surface of the under cladding layer 1, and side end edges of the respective positioning members P are brought into abutment with vertical walls of the above-mentioned protruding portions 4. Further, the fitting plate portions 5b in the above-mentioned substrate unit E₂ are brought into fitting engagement with the pair of groove portions 3b in the optical waveguide unit W₂ for fitting engagement with the substrate unit. In this manner, the above-mentioned optical waveguide unit W₂ and the substrate unit E₂ are integrated together (with reference to FIG. 1). It should be noted that at least either the positioning portions of the above-mentioned protruding portions 4 and the positioning plate portions 5a or the fitting engagement portions of the groove portions 3b and the fitting plate portions 5b may be fixed with an adhesive. Such fixing with an adhesive allows the positional relationship between the above-mentioned optical waveguide unit W₂ and the substrate unit E₂ to be maintained with higher stability against impacts, vibrations and the like. In this manner, the intended optical sensor module is completed.

The coupling between the above-mentioned optical waveguide unit W₂ and the substrate unit E₂ is provided typically using an auxiliary device such as an optical microscope and the like because the slit width of the protruding portions 4 and the groove width of the groove portions 3b are narrow.

In the above-mentioned optical waveguide unit W₂, as mentioned earlier, the end surface 2a of the core 2 and the protruding portions 4 for the positioning of the substrate unit are in a highly precise positional relationship, and the end surface 2a of the core 2 and the groove portions 3b for fitting engagement with the substrate unit are in an appropriate positional relationship. In the substrate unit E₂ with the above-mentioned optical element 8 mounted therein, the optical element 8 and the positioning members P of the positioning plate portions 5a to be positioned in the protruding portions 4 are in a highly precise positional relationship, and the optical element 8 and the fitting plate portions 5b for fitting engagement with the above-mentioned groove portions 3b are also in an appropriate positional relationship. Additionally, the above-mentioned protruding portions 4 have a height less than 50 μm, but the above-mentioned positioning members P have substantially right-angled corners that are hardly rounded. As a result, in the above-mentioned optical sensor module configured such that the positioning members P of the above-mentioned positioning plate portions 5a are positioned in the above-mentioned protruding portions 4 and such that the above-mentioned fitting plate portions 5b are in fitting engagement with the above-mentioned groove portions 3b, the end surface 2a of the core 2 and the optical element 8 are automatically placed in a highly precise positional relationship without any alignment operation, and the highly precise positional relationship is maintained. This enables the above-mentioned optical sensor module to achieve the appropriate propagation of light between the end surface 2a of the core 2 and the optical element 8.

The optical waveguide unit W₂ includes the pair of protruding portions 4 for the positioning of the substrate unit in this embodiment, but may include any one of the two protruding portions 4. In that case, the one protruding portion 4 is preferably longer (longer in the X direction of FIG. 1). Also, the above-mentioned protruding portions 4 are formed to have the generally U-shaped plan configuration. However, if the positioning of the substrate unit E₂ is achieved, the protruding portions 4 may have other configurations. For example, the protruding portions 4 may have an L-shaped plan configuration that is a portion of the above-mentioned generally U-shaped plan configuration.

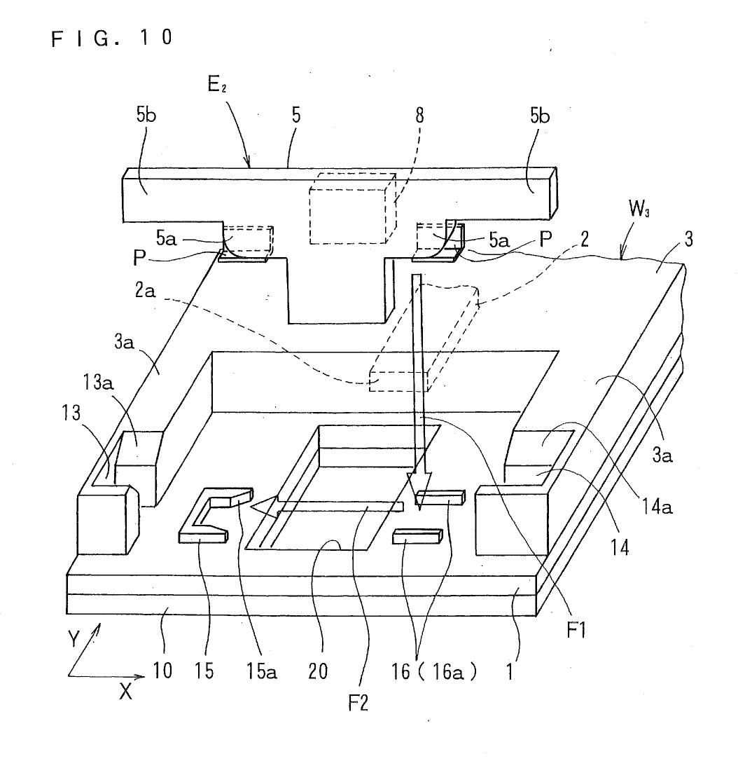

FIG. 10 is a perspective view schematically showing a first end portion of an optical waveguide unit of an optical sensor module according to a second embodiment of the present invention. The optical sensor module according to the second embodiment is configured such that an optical waveguide unit W₃ includes a pair of first and second groove portions 13 and 14 formed with respective tapered portions 13a and 14a, and a pair of first and second protruding portions 15 and 16, the first (left-hand as seen in the figure) protruding portion 15 being formed with a tapered portion 15a, the second (right-hand as seen in the figure) protruding portion 16 being formed as a guide portion comprised of two parallel strips 16a, so that the positioning of the substrate unit E₂ is facilitated in the optical sensor module according to the first embodiment shown in FIG. 1. Other parts are similar to those of the first embodiment shown in FIG. 1. Like reference numerals and characters are used to designate similar parts.

More specifically, portions of the pair of above-mentioned groove portions 13 and 14, respectively, corresponding to an upper surface portion of the over cladding layer 3 are the tapered portions 13a and 14a having a width decreasing gradually in a downward direction from the upper surface of the over cladding layer 3. The tapered portions 13a and 14a extend partway in the longitudinal direction of the groove portions 13 and 14 (in the direction of the thickness of the over cladding layer 3). Portions of the groove portions 13 and 14 below the tapered portions 13a and 14a have a uniform width, as in the first embodiment shown in FIG. 1. The position of the lower ends of the tapered portions 13a and 14a is preferably level with or above the position in which the lower end edges of the fitting plate portions 5b of the substrate unit E₂ lie when the optical waveguide unit W₃ and the substrate unit E₂ are coupled together. The width of the above-mentioned tapered portions 13a and 14a at their upper ends (at the upper surface of the over cladding layer 3) is, for example, in the range of 1.0 to 3.0 mm from the viewpoint of attaining such size as to enable an operator to easily bring the fitting plate portions 5b of the substrate unit E₂ into fitting engagement with the tapered portions 13a and 14a through visual observation. The widths of the lower end of the tapered portions 13a and 14a and the portions of the uniform width below the tapered portions 13a and 14a are, for example, in the range of 0.2 to 0.4 mm. Further, in the second embodiment, the depth of the second (right-hand as seen in the figure) groove portion 14 is approximately 1.0 to 3.0 mm greater than that of the first (left-hand as seen in the figure) groove portion 13.

Of the pair of above-mentioned protruding portions 15 and 16, the first (left-hand as seen in the figure) protruding portion 15 is formed in a generally U-shaped plan configuration, and has an generally U-shaped opening portion in the form of the tapered portion 15a having a width decreasing gradually in an inward direction from the opening end thereof. The tapered portion 15a extends partway in the inward direction of the generally U-shaped configuration. A portion of the groove portion 15 inside the tapered portion 15a has a uniform width, as in the first embodiment shown in FIG. 1. Preferably, the opening width of the opening end of the above-mentioned tapered portion 15a is slightly greater than the width (0.2 to 0.4 mm) of the lower ends of the tapered portions 13a and 14a of the above-mentioned groove portions 13 and 14. The widths of the inside end of the tapered portion 15a of the above-mentioned protruding portion 15 and the portion of the uniform width inside the tapered portion 15a are, for example, approximately 0.1 mm, and the lengths thereof are, for example, approximately 1.0 mm. The width of the lines forming the generally U-shaped plan configuration is preferably in the range of 0.05 to 0.2 mm.

On the other hand, the second (right-hand as seen in the figure) protruding portion 16 is formed as the guide portion comprised of the two parallel strips 16a. Preferably, the spacing between the two strips 16a is slightly greater than the width (0.2 to 0.4 mm) of the lower ends of the tapered portions 13a and 14a of the above-mentioned groove portions 13 and 14. Preferably, the length of the two above-mentioned strips 16a is, for example, not less than 1.0 mm.

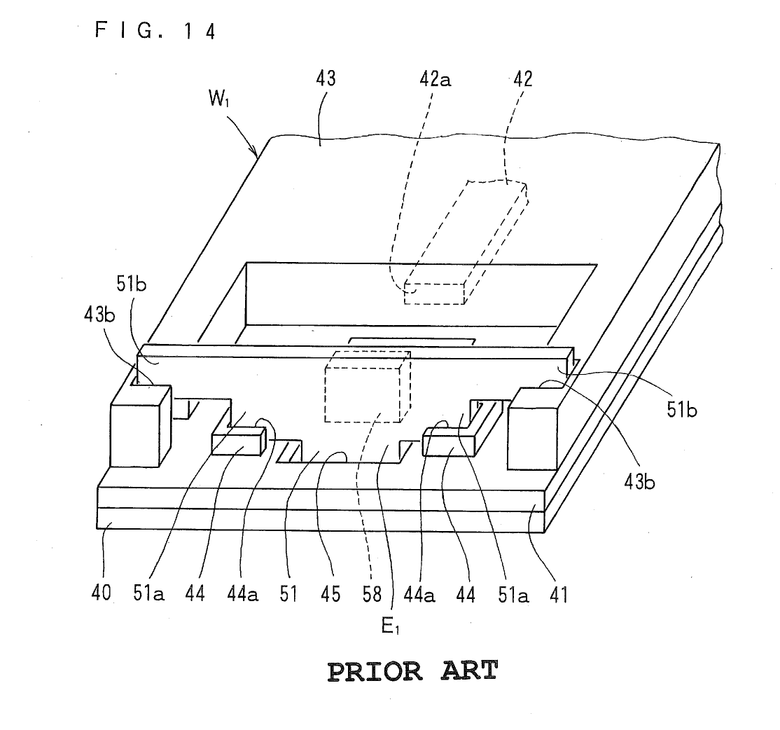

The optical waveguide unit W₃ and the substrate unit E₂ are coupled to each other in a manner to be described below. First, the surface of the optical element 8 of the substrate unit E₂ is directed to face toward the end surface 2a of the core 2 of the optical waveguide unit W₃. In that state, the substrate unit E₂ is moved slightly toward the groove portion (the right-hand groove portion as seen in the FIG. 14 having the greater depth, and the fitting plate portions 5b of the substrate unit E₂ are positioned over the groove portions 13 and 14 of the optical waveguide unit W₃. Then, the substrate unit E₂ is moved downwardly (as indicated by the arrow F1 in the figure). The fitting plate portions 5b of the substrate unit E₂ are inserted into the tapered portions 13a and 14a of the groove portions 13 and 14, and the lower end edges of the positioning members P of the positioning plate portions 5a of the substrate unit E₂ are placed on the surface of the above-mentioned under cladding layer 1. At this time, the position of the substrate unit E₂ along the Y-axis is coarsely adjusted by the tapered portions 13a and 14a of the above-mentioned groove portions 13 and 14, and the lower end edges of the positioning members P of the positioning plate portions 5a of the substrate unit E₂ are positioned between the two parallel strips 16a of the second (right-hand as seen in the figure) protruding portion 16. Next, the substrate unit E₂ is slid toward the groove portion 13 (left-hand as seen in the figure) having the smaller depth (as indicated by the arrow F2 in the figure). The left-hand end edge of the positioning members P of the positioning plate portions 5a of the substrate unit E₂ is inserted into the tapered portion 15a of the first (left-hand as seen in the figure) protruding portion 15, and is brought into abutment with the vertical wall at the inside end of the protruding portion 15. At this time, the position of the substrate unit E₂ along the Y-axis is appropriately adjusted by the tapered portion 15a of the above-mentioned protruding portion 15, and the position thereof along the X-axis is appropriately adjusted by the abutment against the vertical wall at the above-mentioned inside end. In this manner, the optical waveguide unit W₃ and the substrate unit E₂ are integrated together to provide an optical sensor module.

In the second embodiment, the tapered portions 13a, 14a and 15a are formed in the groove portions 13 and 14, and the protruding portion 15, respectively. This provides the coupling between the optical waveguide unit W₃ and the substrate unit E₂ without using an auxiliary device such as an optical microscope and the like.

In the second embodiment, the tapered portions 13a and 14a of the respective groove portions 13 and 14 extend partway in the longitudinal direction of the groove portions 13 and 14. However, when the lower end edges of the fitting plate portions 5b for fitting engagement with the groove portions 13 and 14 come in abutment with the surface of the under cladding layer 1, the tapered portions 13a and 14a of the respective groove portions 13 and 14 may extend to the lower ends of the groove portions 13 and 14 (to the surface of the under cladding layer 1).

Also, in this embodiment, the positioning of the substrate unit E₂ relative to the optical waveguide unit W₃ is easier. For this reason, the guide portion (the protruding portion 16) comprised of the two parallel strips 16a need not be formed in some cases. In this case, the first protruding portion 15 having the generally U-shaped plan configuration is preferably longer (longer in the X direction of FIG. 10).

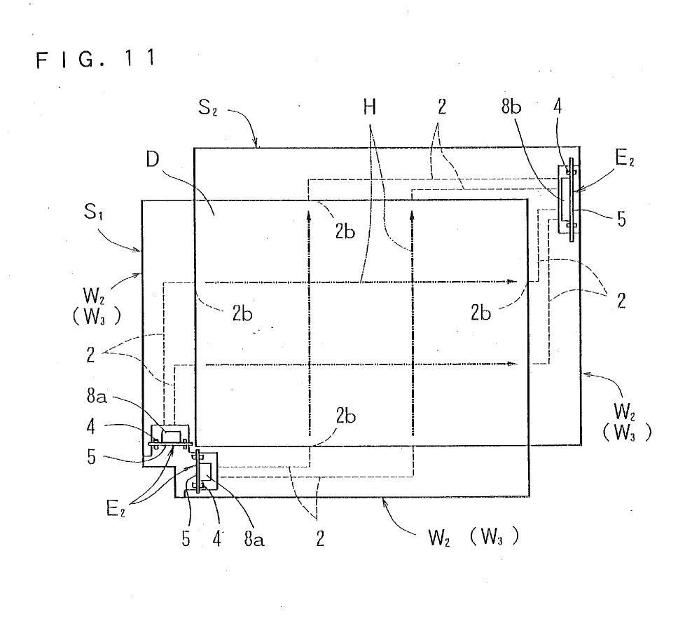

The above-mentioned optical sensor module according to the present invention may be used as a detection means for detecting a finger touch position and the like on a touch panel. This is done, for example, by forming two L-shaped optical sensor modules S₁ and S₂ and using the two L-shaped optical sensor modules S₁ and S₂ opposed to each other in the form of a rectangular frame, as shown in FIG. 11. Specifically, the first L-shaped optical sensor module S₁ is configured such that two substrate units E₂ with respective light-emitting elements 8a such as semiconductor lasers and the like mounted therein are in fitting engagement with a corner portion thereof, and such that the front end surfaces 2b of respective cores 2 and the lens surface of the over cladding layer 3 from which light beams H are emitted face toward the inside of the above-mentioned frame. The second L-shaped optical sensor module S₂ is configured such that a single substrate unit E₂ with a light-receiving element 8b such as a photodiode and the like mounted therein is in fitting engagement with a corner portion thereof, and such that the lens surface of the over cladding layer 3 and the front end surfaces 2b of respective cores 2 which receive the light beams H face toward the inside of the above-mentioned frame. The above-mentioned two L-shaped optical sensor modules S₁ and S₂ are arranged along the rectangle of the periphery of a display screen of a rectangular display D of the touch panel so as to surround the display screen, so that the light beams H emitted from the first L-shaped optical sensor module S₁ are received by the second L-shaped optical sensor module S₂. This allows the above-mentioned emitted light beams H to travel in parallel with the display screen and in a lattice form on the display screen of the display D. When a portion of the display screen of the display D is touched with a finger, the finger blocks some of the emitted light beams H. Thus, the light-receiving element 8b senses a light blocked portion, whereby the position of the above-mentioned portion touched with the finger is detected. In FIG. 11, the cores 2 are indicated by broken lines, and the thickness of the broken lines indicates the thickness of the cores 2. Also, the number of cores 2 is shown as abbreviated.

In the above-mentioned embodiments, the lower end edge portions of the respective positioning members P are bent in the step of producing the substrate unit E₂. However, the lower end edge portions of the respective positioning members P may be placed on the surface of the under cladding layer 1 without being bent.

Also, the positioning members P and the mounting pad 7 are formed at the same time in the step of producing the substrate unit E₂ in the above-mentioned embodiments, but need not be formed at the same time.

In the above-mentioned embodiments, the insulation layer 6 is formed for the production of the substrate unit E₂. This insulation layer 6 is provided for the purpose of preventing a short circuit from occurring between the substrate 5A having electrical conductivity such as a metal substrate and the mounting pad 7. For this reason, when the substrate 5A has insulating properties, the mounting pad 7 and the positioning members P may be formed directly on the above-mentioned substrate 5A without the formation of the insulation layer 6.

Next, inventive examples of the present invention will be described in conjunction with comparative examples and a reference example. It should be noted that the present invention is not limited to the inventive examples.

### EXAMPLES

### Material for Formation of Under Cladding Layer and Over Cladding Layer (Including Extensions)

A material for the formation of an under cladding layer and an over cladding layer is prepared by mixing 35 parts by weight of bisphenoxyethanolfluorene diglycidyl ether (component A), 40 parts by weight of 3′,4′-epoxycyclohexylmethyl-3,4-epoxycyclohexanecarboxylate which is an alicyclic epoxy resin (CELLOXIDE 2021P manufactured by Daicel Chemical Industries, Ltd.) (component B), 25 parts by weight of (3′,4′-epoxycyclohexane)methyl-3′,4′-epoxycyclohexyl carboxylate (CELLOXIDE 2081 manufactured by Daicel Chemical Industries, Ltd.) (component C), and 2 parts by weight of a 50% by weight propione carbonate solution of 4,4′-bis[di((β-hydroxyethoxy)phenylsulfinio]phenylsulfide bishexafluoroantimonate (component D).

### Material for Formation of Core and Protruding Portions

A material for the formation of a core and protruding portions was prepared by dissolving 70 parts by weight of the aforementioned component A, 30 parts by weight of 1,3,3-tris{4-[2-(3-oxetanyl)]butoxyphenyl}butane, and one part by weight of the aforementioned component D in ethyl lactate.

### Inventive Example 1

### Production of Optical Waveguide Unit

The material for the formation of the above-mentioned under cladding layer was applied to a surface of a sheet material made of stainless steel (having a thickness of 50 μm) with an applicator. Thereafter, exposure by the use of irradiation with ultraviolet light (having a wavelength of 365 nm) at 2000 mJ/cm² was performed, to thereby form the under cladding layer (having a thickness of 20 μm) (with reference to FIG. 6A).

Then, the material for the formation of the above-mentioned core and the protruding portions was applied to a surface of the above-mentioned under cladding layer with an applicator. Thereafter, a drying process was performed at 100° C. for 15 minutes to form a photosensitive resin layer (with reference to FIG. 6B). Next, a synthetic quartz chrome mask (photomask) formed with an opening pattern identical in shape with the pattern of the core and the protruding portions were placed over the photosensitive resin layer. Then, exposure by the use of irradiation with ultraviolet light (having a wavelength of 365 nm) at 4000 mJ/cm² was performed by a proximity expo sure method from over the mask. Thereafter, a heating treatment was performed at 80° C. for 15 minutes. Next, development was carried out using an aqueous solution of γ-butyrolactone to dissolve away unexposed portions. Thereafter, a heating treatment was performed at 120° C. for 30 minutes to thereby form the core of a rectangular sectional configuration (having a thickness of 20 μm and a width of 50 μm), and the pair of protruding portions of a generally U-shaped plan configuration (including vertical walls with a height of 20 μm, a slit portion of a generally U-shaped plan configuration with a slit width of 0.1 mm, and lines of a generally U-shaped plan configuration with a width of 0.2 mm). The pair of protruding portions were equally spaced apart from an end surface of the core. A distance between a line connecting the pair of protruding portions and the end surface of the core was 0.3 mm, and a distance between the pair of protruding portions was 8 mm (with reference to FIG. 6C).

Next, a molding die made of quartz (with reference to FIG. 7A) for the die-molding of the over cladding layer and groove portions for fitting engagement with a substrate unit (the extensions of the over cladding layer) at the same time was set in an appropriate position by using the end surface of the core as a reference (with reference to FIG. 7B). Then, the material for the formation of the above-mentioned over cladding layer and the extensions thereof was injected into a mold space. Thereafter, exposure by the use of irradiation with ultraviolet light at 2000 mJ/cm² was performed through the molding die. Subsequently, a heating treatment was performed at 120° C. for 15 minutes. Thereafter, the die was removed. This provided the over cladding layer (having a thickness of 1 mm as measured from the surface of the under cladding layer), and the groove portions for fitting engagement with the substrate unit (with reference to FIG. 7C). The above-mentioned groove portions had the following dimensions: a depth of 1.5 mm, a width of 0.2 mm, and a distance of 14.0 mm between the bottom surfaces of the respective groove portions opposed to each other.

### Production of Substrate Unit

An insulation layer (having a thickness of 10 μm) made of a photosensitive polyimide resin was formed on a portion of a surface of a stainless steel substrate [25 mm×30 mm×50 μm (thick)] (with reference to FIG. 8A). Then, a semi-additive process was performed to form a seed layer made of copper/nickel/chromium alloy, and an electro copper plated layer (having a thickness of 10 μm) in a stacked manner on a surface of the above-mentioned insulation layer. Further, a gold/nickel plating process (gold/nickel=0.2/2 μm) was performed to form an optical element mounting pad, a second bonding pad, an electric interconnect line, and positioning members (with reference to FIG. 8B).

Next, the stainless steel substrate was etched using a dry film resist so that positioning plate portions and fitting plate portions were formed in appropriate positions relative to the above-mentioned optical element mounting pad. This provided a shaping substrate (with reference to FIG. 8C). Thereafter, excess portions of the insulation layer were etched away by using a dry film resist in a similar manner (with reference to FIG. 9A). The above-mentioned dry film resists in the respective steps were stripped away using an aqueous sodium hydroxide solution. Then, the lower end edge portions of the above-mentioned positioning members extending out of the lower end edges of the above-mentioned positioning plate portions together with portions of the insulation layer on the back surface thereof were bent toward the positioning plate portions, while being put against a plate member (with reference to FIG. 9B).

A silver paste was applied to a surface of the above-mentioned optical element mounting pad. Thereafter, a high-precision die bonder (mounting apparatus) was used to mount a light-emitting element of a wire bonding type (a VCSEL chip SM85-2N001 manufactured by Optowell Co., Ltd.) onto the above-mentioned silver paste. Then, a curing process (at 180° C. for one hour) was performed to harden the above-mentioned silver paste. Thereafter, gold wires having a diameter of 25 μm were used to form gold wire loops by wire bonding, and the above-mentioned light-emitting element and its surrounding portion were sealed with a transparent resin (NT resin manufactured by Nitto Denko Corporation) for an LED by potting (with reference to FIG. 9C). In this manner, a substrate unit was produced. The size of the positioning plate portions of the substrate unit was defined in accordance with the size of the above-mentioned pair of protruding portions, and the size of the fitting plate portions was defined in accordance with the size of the above-mentioned pair of groove portions.

### Manufacture of Optical Sensor Module

First, the substrate unit was held with tweezers. Under observation with an optical microscope, the positioning plate portions in the above-mentioned substrate unit were positioned in the slit portions of the pair of protruding portions having the generally U-shaped plan configuration in the above-mentioned optical waveguide unit for the positioning of the substrate unit. Then, the lower end edges of the respective positioning members defining the corners of the positioning plate portions were placed on the surface of the under cladding layer, and side end edges of the respective positioning members were brought into abutment with vertical walls at the inside ends of the above-mentioned protruding portions. Further, the fitting plate portions in the above-mentioned substrate unit were brought into fitting engagement with the pair of groove portions in the optical waveguide unit for fitting engagement with the substrate unit. Thereafter, the positioning portions and the fitting engagement portions were fixed with an adhesive. In this manner, an optical sensor module was manufactured (with reference to FIG. 1).

### Inventive Example 2

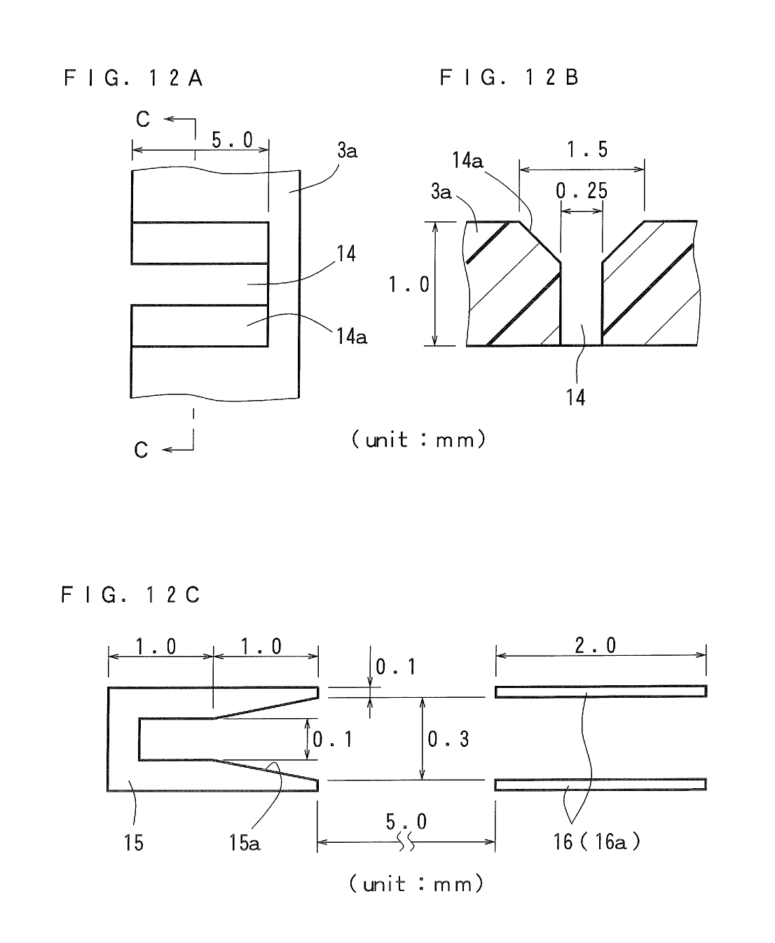

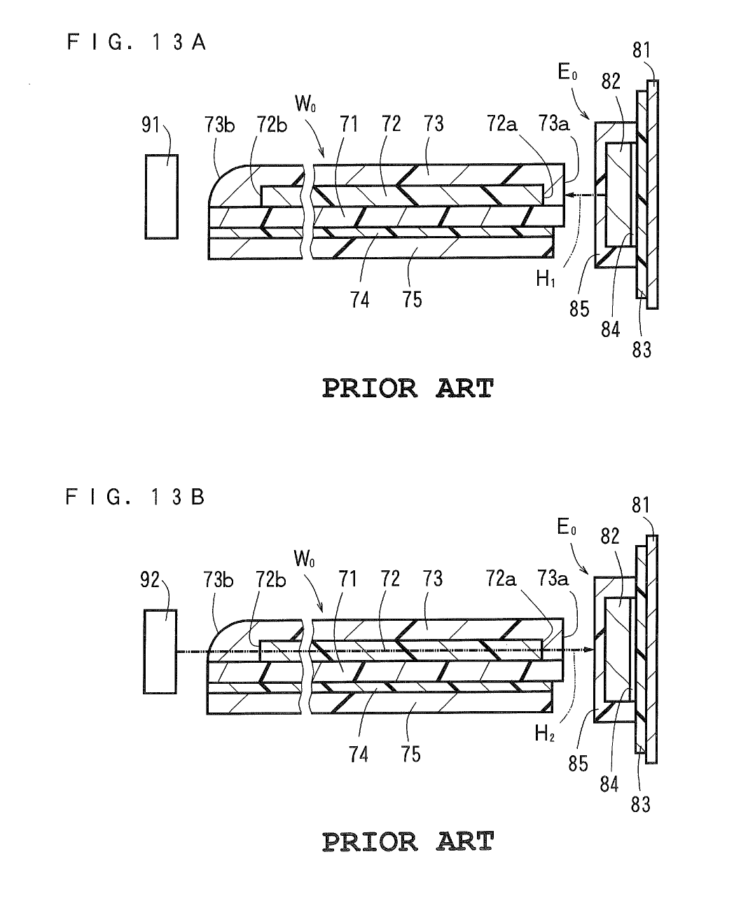

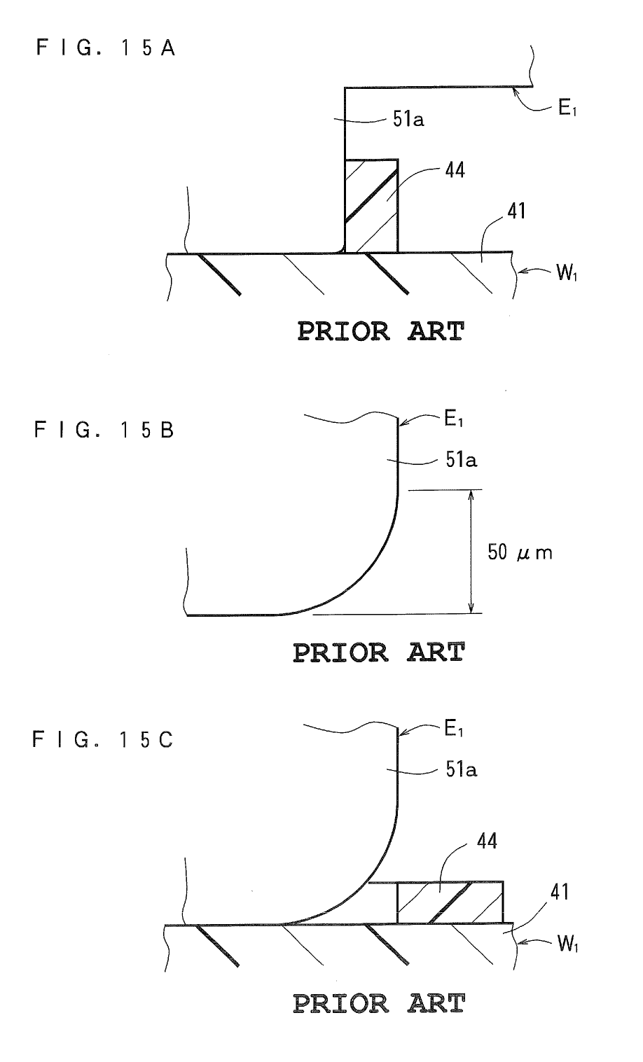

Portions of the pair of groove portions corresponding to an upper surface portion of the over cladding layer in Inventive Example 1 described above were formed as tapered portions (with reference to FIG. 10). The dimensions of the groove portions were shown in FIGS. 12A and 12B. FIGS. 12A and 12B show the groove portion 14 having the greater depth (a depth of 5.0 mm). The groove portion 13 having the smaller depth (with reference to FIG. 10) had a depth of 3.0 mm. The remaining dimensions of the groove portion 13 were similar to those of the groove portion 14 having the greater depth. Of the pair of protruding portions 15 and 16, as shown in FIG. 12C, the protruding portion (left-hand as seen in the FIG. 15 closer to the groove portion 13 having the smaller depth was formed in a generally U-shaped plan configuration, and had a generally U-shaped opening portion in the form of the tapered portion 15a, whereas the protruding portion (right-hand as seen in the FIG. 16 closer to the groove portion 14 having the greater depth was formed as a guide portion comprised of the two parallel strips 16a. The dimensions of the protruding portions 15 and 16 are also shown in FIG. 12C. Except for these differences, Inventive Example 2 was similar to Inventive Example 1 described above.

### Manufacture of Optical Sensor Module

First, the substrate units were held with operator's fingertips. The substrate unit was moved slightly toward the groove portion 14 having the greater depth, and the fitting plate portions of the substrate unit were positioned over the groove portions 13 and 14 of the optical waveguide unit (with reference to FIG. 10). Then, the substrate unit was moved downwardly. The fitting plate portions of the substrate unit were inserted into the tapered portions 13a and 14a of the groove portions 13 and 14, and the lower end edges of the positioning members of the positioning plate portions of the substrate unit were placed on the surface of the above-mentioned under cladding layer. At this time, the position of the substrate unit along the Y-axis was coarsely adjusted by the tapered portions 13a and 14a of the above-mentioned groove portions 13 and 14, and the lower end edges of the positioning members of the positioning plate portions of the substrate unit were positioned between the two parallel strips 16a of the second (right-hand as seen in the figure) protruding portion 16. Next, the substrate unit was slid toward the groove portion 13 having the smaller depth. The left-hand end edge of the positioning members of the positioning plate portions of the substrate unit was inserted into the tapered portion 15a of the first (left-hand as seen in the figure) protruding portion 15, and was brought into abutment with the vertical wall at the inside end of the protruding portion 15. At this time, the position of the substrate unit along the Y-axis was appropriately adjusted by the tapered portion 15a of the above-mentioned protruding portion 15, and the position thereof along the X-axis was appropriately adjusted by the abutment against the vertical wall at the above-mentioned inside end. Thereafter, the positioning portions and the fitting engagement portions were fixed with an adhesive. In this manner, an optical sensor module was manufactured (with reference to FIG. 10). No optical microscope was used for the coupling between the optical waveguide unit and the substrate unit.

### Inventive Example 3

The height of the vertical walls of the protruding portions and the thickness of the core in Inventive Example 1 described above were 30 μm. Except for this difference, Inventive Example 3 was similar to Inventive Example 1 described above.

### Inventive Example 4

The height of the vertical walls of the protruding portions and the thickness of the core in Inventive Example 2 described above were 30 μm. Except for this difference, Inventive Example 4 was similar to Inventive Example 2 described above.

### Inventive Example 5

The height of the vertical walls of the protruding portions and the thickness of the core in Inventive Example 1 described above were 45 μm. Except for this difference, Inventive Example 5 was similar to Inventive Example 1 described above.

### Inventive Example 6

The height of the vertical walls of the protruding portions and the thickness of the core in Inventive Example 2 described above were 45 μm. Except for this difference, Inventive Example 6 was similar to Inventive Example 2 described above.

### Comparative Example 1

The substrate unit in which the positioning members were not formed was used in Inventive Example 1 described above. Except for this difference, Comparative Example 1 was similar to Inventive Example 1 described above.

### Comparative Example 2

The height of the vertical walls of the protruding portions and the thickness of the core in Comparative Example 1 described above were 45 μm. Except for this difference, Comparative Example 2 was similar to Comparative Example 1 described above.

### Reference Example

The height of the vertical walls of the protruding portions and the thickness of the core in Inventive Example 1 described above were 50 μm, The substrate unit in which the positioning members were not formed was used. Except for these differences, Reference Example was similar to Inventive Example 1 described above.

### Optical Coupling Loss

Current was fed through the light-emitting element of the optical sensor module in Inventive Examples 1 to 6, Comparative Examples 1 and 2, and Reference Example described above to cause the light-emitting element to emit light. Then, the intensity of the light emitted from an end portion of the optical sensor module was measured, and an optical coupling loss was calculated.

The results of the calculation were listed in Table 1 below.

TABLE 1

| Inventive | | | | | | Comp. | | Ref. |
|---|---|---|---|---|---|---|---|---|
| Examples | | | | | | Examples | | Exam- |
| 1 | 2 | 3 | 4 | 5 | 6 | 1 | 2 | ples |

| | | | | | | |
|---|---|---|---|---|---|---|
| Height of | 20 | 30 | 45 | 30 | 45 | 50 |
| Protruding | | | | | | |
| Portions | | | | | | |
| (μm) | | | | | | |

| Position- | Present | Absent | | |
|---|---|---|---|---|
| ing | | | | |
| Members | | | | |
| Optical | 0.7 | 1.9 | 1.6 | 0.8 |
| Coupling | | | | |
| Loss | | | | |
| (dB) | | | | |

The results in Table 1 described above show that the manufacturing method in any one of Inventive Examples 1 to 6, Comparative Examples 1 and 2, and Reference Example described above allows the optical sensor module obtained thereby to propagate light without any alignment operation of the core of the optical waveguide unit and the light-emitting element of the substrate unit. However, it is found that each of the optical sensor modules in Comparative Examples 1 and 2 is greater in optical coupling loss and hence becomes worse in the positioning accuracy (alignment accuracy) of the substrate unit relative to the optical waveguide unit. The reason for this is that the roundness of the corners of the positioning plate portions prevents the above-mentioned positioning plate portions from appropriately abutting against the vertical walls of the protruding portions have a height less than 50 μm. It is found that the optical sensor module in Reference Example is small in optical coupling loss. This shows that, although the positioning plate portions have rounded corners, the optical sensor module in Reference Example includes the protruding portions having the vertical walls as high as 50 μm to allow the positioning plate portions to appropriately abut against the vertical walls of the protruding portions.

### Time Required for Positioning

It took 20 seconds to provide the coupling between the optical waveguide unit and the substrate unit in Inventive Examples 1, 3 and 5 described above, and it took five seconds in Inventive Examples 2, 4 and 6 described above.

This result shows that Inventive Examples 2, 4 and 6 described above, in which the above-mentioned tapered portions are formed in the groove portions and in the protruding portions, are capable of providing the coupling between the optical waveguide unit and the substrate unit without using any auxiliary device such as an optical microscope and the like and yet quickly. In other words, Inventive Examples 2, 4 and 6 provide excellent productivity.

The optical sensor module according to the present invention maybe used for a detection means for detecting a finger touch position and the like on a touch panel, or for information communications equipment and signal processors for transmitting and processing digital signals representing sound, images and the like at high speeds.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A method of manufacturing an optical sensor module with a substrate unit in orthogonal relation to an optical waveguide unit, comprising the steps of:
preparing an optical waveguide unit including an under cladding layer, and protruding portions having vertical walls for the positioning of a substrate unit, the protruding portions being formed on a surface portion of the under cladding layer lying in an appropriate position for the transmission and reception of light relative to a light-transmitting and light-receiving end portion of a core;
preparing a substrate unit including an optical element mounted therein, and positioning plate portions formed by etching, the positioning plate portions having respective lower end edges and respective corners, the positioning plate portions being positioned by the placement of the lower end edges thereof on the surface of the under cladding layer and by the abutment of the corners thereof against the vertical walls of the protruding portions so that the optical element is in an appropriate position relative to the light-transmitting and light-receiving end portion of the core; and
placing the substrate unit in orthogonal relation to the optical waveguide unit, and positioning the positioning plate portions of the substrate unit relative to the under cladding layer and the protruding portions of the optical waveguide unit, thereby positioning and fixing the substrate unit to the optical waveguide unit,
wherein, in the optical waveguide unit, the vertical walls of the protruding portions for the positioning of the substrate unit have a height less than 50 μm, and
wherein, in the substrate unit, each of the corners of the positioning plate portions has at least a portion formed as a positioning member made of the same material as an interconnecting metal layer of the substrate unit, whereby the corners become substantially right-angled corners.

2. The method of manufacturing the optical sensor module according to claim 1, wherein the positioning members are formed in an appropriate position relative to an optical element mounting pad by a photolithographic process using a single photomask at the same time that the optical element mounting pad constituting the interconnecting metal layer is formed.

3. The method of manufacturing the optical sensor module according to claim 1, wherein portions of the respective positioning members to be placed on the under cladding layer are bent prior to the positioning of the substrate unit relative to the optical waveguide unit.

4. The method of manufacturing the optical sensor module according to claim 1, wherein the protruding portions of the optical waveguide unit are formed to have a generally U-shaped plan configuration.

5. The method of manufacturing the optical sensor module according to claim 1,
wherein groove portions for fitting engagement with the substrate unit are formed in an over cladding layer of the optical waveguide unit, the groove portions extending in a direction of the thickness of the over cladding layer, the groove portions being configured to make the substrate unit orthogonal to the optical waveguide unit and to guide the substrate unit in an appropriate condition, the groove portions having a width decreasing gradually in a downward direction from the upper surface of the over cladding layer, and
wherein the protruding portions of the optical waveguide unit are formed to have a generally U-shaped plan configuration, and have generally U-shaped opening portions, respectively, having a width decreasing gradually in an inward direction from the opening end thereof.

6. An optical sensor module comprising:
an optical waveguide unit including an under cladding layer, and protruding portions having vertical walls for the positioning of a substrate unit, the protruding portions being formed on a surface portion of the under cladding layer lying in an appropriate position for the transmission and reception of light relative to a light-transmitting and light-receiving end portion of a core; and
a substrate unit including an optical element mounted therein, and positioning plate portions formed by etching, the positioning plate portions having respective lower end edges and respective corners, the positioning plate portions being positioned by the placement of the lower end edges thereof on the surface of the under cladding layer and by the abutment of the corners thereof against the vertical walls of the protruding portions so that the optical element is in an appropriate position relative to the light-transmitting and light-receiving end portion of the core,
wherein the substrate unit is placed in orthogonal relation to the optical waveguide unit, and the positioning plate portions of the substrate unit are positioned as mentioned above relative to the under cladding layer and the protruding portions of the optical waveguide unit, whereby the substrate unit is positioned and fixed to the optical waveguide unit,
wherein, in the optical waveguide unit, the vertical walls of the protruding portions for the positioning of the substrate unit have a height less than 50 μm, and
wherein, in the substrate unit, each of the corners of the positioning plate portions has at least a portion formed as a positioning member made of the same material as an interconnecting metal layer of the substrate unit, whereby the corners become substantially right-angled corners.

7. The optical sensor module according to claim 6, wherein the positioning members are formed in an appropriate position relative to an optical element mounting pad constituting the interconnecting metal layer.

8. The optical sensor module according to claim 6, wherein portions of the respective positioning members to be placed on the under cladding layer are bent.

9. The optical sensor module according to claim 6, wherein the protruding portions of the optical waveguide unit are formed to have a generally U-shaped plan configuration.

10. The optical sensor module according to claim 6,
wherein groove portions for fitting engagement with the substrate unit are formed in an over cladding layer of the optical waveguide unit, the groove portions extending in a direction of the thickness of the over cladding layer, the groove portions being configured to make the substrate unit orthogonal to the optical waveguide unit and to guide the substrate unit in an appropriate condition, the groove portions having a width decreasing gradually in a downward direction from the upper surface of the over cladding layer, and
wherein the protruding portions of the optical waveguide unit are formed to have a generally U-shaped plan configuration, and have generally U-shaped opening portions, respectively, having a width decreasing gradually in an inward direction from the opening end thereof.
